(19) United States
(12) Patent Application Publication
(10) Pub. No.: US 2010/0153050 A1
(43) Pub. Date: Jun. 17, 2010

(54) Autonomous Underwater Vehicle Borne Gravity Meter

(76) Inventors: Mark A. Zumberge, San Diego, CA (US); Glenn Sasagawa, Encinitas, CA (US); Richard Zimmerman, San Diego, CA (US); Jeff Ridgway, San Diego, CA (US)

Correspondence Address: FISH & RICHARDSON, PC, P.O. BOX 1022, MINNEAPOLIS, MN, 55440-1022, US

(21) Appl. No.: 12/617,688

(22) Filed: Nov. 12, 2009

Related U.S. Application Data
(60) Provisional application No. 61/113,493, filed on Nov. 11, 2008.

(51) Int. Cl. G01V 7/00; G05D 1/00; B63G 8/00; G06F 19/00

(52) U.S. Cl. 702/92; 73/382 R

(57) ABSTRACT

Techniques and systems are disclosed for performing a gravity survey near the seafloor. In one aspect, a system includes an autonomous underwater vehicle that includes a sensor system holding area. The system includes a gravity sensor system to fit inside the sensor system holding area of the autonomous underwater vehicle. The gravity sensor system includes a motorized gimbal to provide a leveled sensor platform. Also, the gravity sensor system includes a gravimeter sensor mounted onto the motorized gimbal to measure gravity data. Further, the payload includes a motion sensor mounted onto the motorized gimbal to measure motion data associated with movements of the autonomous underwater vehicle.

### CLAIM OF PRIORITY

This application claims priority under 35 USC §119(e) to U.S. Patent Application Ser. No. 61/113,493, filed on Nov. 11, 2008, the entire contents of which are hereby incorporated by reference.

### BACKGROUND

This application relates to a gravity meter for detecting geologic structures beneath the seafloor.

Gravity measurements can be obtained using a gravity meter located onboard a ship. The obtained gravity measurements can be used to identify geological structures beneath the seafloor. These measurements are affected by various movements of the ship. The onboard gravity meter includes a gyroscopic structure to eliminate the component of the measurement attributed to the ship movements. The gyroscopic structure requires additional space and power onboard the ship.

### SUMMARY

Techniques, systems and apparatus are disclosed for performing gravity surveys near the seafloor.

In one aspect, a system includes an autonomous underwater vehicle that includes a sensor system holding area. The system includes a gravity sensor system to fit inside the sensor system holding area of the autonomous underwater vehicle. The gravity sensor system includes a motorized gimbal to provide a leveled sensor platform. Also, the gravity sensor system includes a gravimeter sensor mounted onto the motorized gimbal to measure gravity data. Further, the gravity sensor system includes a motion sensor mounted onto the motorized gimbal to measure motion data associated with movements of the autonomous underwater vehicle. A sensor system housing encapsulates components of the sensor system including the motorized gimbal, the gravimeter sensor and the motion sensor.

Implementations can optionally include one or more of the following features. The sensor housing can include a glass sphere to provide positive buoyancy. The motion sensor can include a non-gyroscopic tilt sensor. The non-gyroscopic tilt sensor can include an accelerometer. Also, the system can include a computing system to communicate with the gravimeter sensor and the motion sensor. The computing system can be configured to receive gravity data from the gravimeter sensor; receive motion data from the motion sensor; and modify the received gravity data based on the received motion data. The computing system can be configured to modify the received gravity data by removing a component of the received gravity data associated with the received motion data. The motorized gimbal can be configured to generate movements to perform active compensation of low frequency noise associated with the movements of the autonomous underwater vehicle. The computing system can be configured to use the received motion data from the motion sensor to compensate or eliminate high frequency noise associated with the movements of the autonomous underwater vehicle. The gravity sensor system can include an insulation unit mounted to the gimbal to house the gravity sensor in a temperature controlled environment, wherein the gravity sensor is indirectly mounted to the gimbal using the insulation unit. The gravity sensor system can be positioned near a center of rotation of the autonomous underwater vehicle.

In another aspect, a method includes at an autonomous underwater vehicle, measuring gravity data along an underwater track near the seafloor. Measuring the gravity data included recording gravity data using a gravity sensor mounted on a motorized gimbal inside the autonomous underwater vehicle; recording motion data associated with movements of the autonomous underwater vehicle using a motion sensor mounted to the motorized gimbal; and modifying the received gravity data based on the received motion data.

Implementations can optionally include one or more of the following features. Modifying the received gravity data can include removing a component of the received gravity data associated with the received motion data. The motorized gimbal can be used to perform active compensation of low frequency noise associated with the movements of the autonomous underwater vehicle. The received motion data from the motion sensor can be used to compensate or eliminate high frequency noise associated with the movements of the autonomous underwater vehicle. A temperature controlled environment can be provided for the gravity sensor system. Additionally, the gravity sensor can be positioned near a center of rotation of the autonomous underwater vehicle.

In another aspect an apparatus (e.g., a gravity sensor device) can include a gravity sensor system sized to fit inside an autonomous underwater vehicle. The gravity sensor system can include a motorized gimbal to provide a leveled sensor platform, a gravimeter sensor mounted onto the motorized gimbal to measure gravity data, and a motion sensor mounted onto the motorized gimbal to measure motion data associated with movements of the autonomous underwater vehicle. A sensor system housing can encapsulate components of the gravity sensor system including the motorized gimbal, the gravimeter sensor and the motion sensor.

Implementations can optionally include one or more of the following features. The sensor system housing can include a glass sphere to provide positive buoyancy for the sensor system. The motion sensor can include a non-gyroscopic tilt sensor. The non-gyroscopic tilt sensor can include an accelerometer. The apparatus can include a computing system to communicate with the gravimeter sensor and the motion sensor. The computing system can be configured to receive gravity data from the gravimeter sensor; receive motion data from the motion sensor; and modify the received gravity data based on the received motion data. Additionally, the computing system can be configured to modify the received gravity data by removing a component of the received gravity data associated with the received motion data. The motorized gimbal can be configured to generate movements to perform active compensation of low frequency noise associated with the movements of the autonomous underwater vehicle. The computing system can be configured to use the received motion data from the motion sensor to compensate or eliminate high frequency noise associated with the movements of the autonomous underwater vehicle. The gravity sensor system can include an insulation unit mounted to the gimbal to house the gravity sensor in a temperature controlled environment, wherein the gravity sensor is indirectly mounted to the gimbal using the insulation unit. The gravity sensor system can be positioned near a center of rotation of the autonomous underwater vehicle.

The subject matter described in this specification potentially can provide one or more of the following advantages. Because vertical acceleration is indistinguishable from gravity, gravity observations should be obtained from a platform whose motions are small, such as an Autonomous Underwater Vehicle (AUV). A gravity meter incorporated into an AUV allows the gravity meter to escape the choppy sea surface for the quieter water below to obtain a significant signal-to-noise improvement. Also, submerged gravity observations are performed closer to the source rocks. Because gravity signals attenuate exponentially with wavelength and distance as an observer moves away from the source, shipboard gravity surveys are limited to studies of features having lateral extent greater than the water depth. By towing a gravimeter just above the sea floor, short wavelength features can be discerned in the ocean such as sulfide mounds, salt dome structures, mid-ocean ridge grabens, and the details of a seamount.

In addition, the subject matter described in this specification can also be implemented as a system including a processor and a memory coupled to the processor. The memory may encode one or more programs that cause the processor to perform one or more of the method acts described in this specification. Further the subject matter described in this specification can be implemented using various machines.

### BRIEF DESCRIPTION OF THE DRAWINGS

FIG. 1 shows an example of a salt dome structure.

FIGS. 2a and 2b show an example AUV-borne gravimeter system.

FIG. 3 shows example signal spectra collected by a towed system and squared coherence between co-located tracks.

FIG. 4 shows example vertical acceleration spectra and accompanying depth time series for a towed vehicle (dashed curve) and an AUV (solid curve).

FIG. 5 shows a comparison of vehicle motions between a Bluefin 21 vehicle and a towed deep-ocean gravimeter (TOWDOG).

FIG. 6 shows an example of gravity change observed with offset angle from vertical.

FIG. 7 shows example navigation tracks from a test deployment of an AUV.

FIG. 8 shows example data from subjecting a Scintrex CG-3 sensor to vertical oscillations at five different periods.

FIG. 9 shows examples of gravity measurements obtained from the sea surface and seafloor.

FIG. 10 shows an example of simulated comparison of gravity data at the ocean surface and ocean bottom.

FIG. 11 shows an example resolution of estimating the thickness of a salt lens as a function of water depth (X axis) and depth to the salt top (Y axis).

FIG. 12 shows an example parametric study of signal-to-noise ratio (SNR) advantage of a AUV-borne gravimeter system vs. a surface gravity gradiometer.

FIG. 13 shows an example of detection threshold as a function of wavelength.

FIG. 14 is a table showing a Bluefin-21 one-day example mission profile. Launch and recovery each take about 15 minutes.

FIGS. 15a, 15b, and 15c are process flow diagrams showing various processes for performing gravimeter survey using an AUV-borne gravity meter sensor system.

Like reference symbols and designations in the various drawings indicate like elements.

### DETAILED DESCRIPTION

The techniques and systems described in this application can be used to obtain gravity measurements closer to the seafloor. For example, a gravity sensing system can be incorporated into an Autonomous Underwater Vehicle (AUV) to produce an AUV-borne gravimeter that can collect gravity data from a location closer to the seafloor. Gravity data can be obtained over potential oil and gas reservoirs beneath the seafloor. Interpretation of such gravity data can help to reveal the geologic structures beneath the seafloor.

While gravity signals can be measured from a gravity meter onboard a ship, the quality of the signals improves as the detection mechanism is moved closer to the source than possible using surface gravity and gradiometer measurements. The AUV-borne gravimeter can increase the resolution of the gravity data by placing the gravity sensor much closer to the source of the gravity-producing mass anomalies and recording a low-noise, high-quality measurement of the vertical gravity field.

Introduction to Gravity Measurements:

The Earth's vertical acceleration due to gravity is approximately 9.8 m/sec² on the earth's surface. Lateral variations in the density of the underlying rock can cause tiny fluctuations in this acceleration field according to the density change, the volume of rock, and its proximity to the sensor (i.e., shallow vs. deep, directly under the sensor vs. far away). Geophysicists have developed methods to measure the gravitational field to a very high precision in order to ascertain information about the earth's structure, using both absolute sensors such as pendulums that provide the entire gravity field's magnitude, and relative methods such as ultra-sensitive spring sensors that provide the change in gravity from one location to another. Because the spatial gravity fluctuations are so small in magnitude, the geophysical unit is presented in milli-Gal (mGal), where one Gal equals 1 cm/sec² and one mGal equals 10⁻³ cm/sec².

Gravity data have been used in synergistic data fusion with seismic, magnetic and magnetotelluric data in oil exploration to discover salt diapirs and to aid in determining the subsurface geologic structure (e.g., Nettleton 1976, Heincke, et al., 2006). Even though current geophysical techniques for oil exploration are dominated by seismic soundings, gravity data still prove very useful and surveys continue to be of high value to oil exploration companies (e.g., Conoco press release, 2000). Gravity anomalies typically interpreted in hydrocarbon exploration are between about 0.1 and 6 mGal in amplitude, and survey precisions can be better than 0.01 mGal using a stationary, extremely accurate spring-type gravimeter and proper surveying techniques. For shipboard sensors, the ship heave and horizontal velocity degrades the measurement accuracy to several tenths of a mGal (e.g., Nettleton, 1976).

Effect of Vertical Range on Gravimeter Resolution:

Lateral features of gravity measurements are attenuated with increasing vertical range. This attenuation of gravity measurements is shown in equation 1:

$$g ( {z}_{0} + z , k ) = g ( {z}_{0} , k ) {e}^{- \frac{2 πz}{λ}} \qquad ( 1 )$$

where g(z₀+z,k) is the gravity at elevation (z₀+z) of an anomaly of lateral wavelength λ corresponding to wavenumber k, with a nominal gravity g(z₀,k) at elevation z₀. Thus, at an increased elevation equal to the lateral scale of a single, sinusoidal anomaly, i.e., λ=z, the gravitational field of the anomaly is reduced fully 500-fold as shown in equation 2 below.

$$\frac{g ( {z}_{0} + λ )}{g ( {z}_{0} )} = {e}^{- 2 π} \approx \frac{1}{500} \qquad ( 2 )$$

Shorter wavelength anomalies are attenuated very quickly with increasing vertical distance. For this reason, land-based gravity surveys are taken as close as possible to the source density structure being measured. Seaborne gravity measurements recorded from a ship, however, are separated from the ideal recording surface (i.e., the bottom) by the water depth. This problem becomes exacerbated with increasing ocean depth. Natural structures are formed by the addition of smaller structures of many wavelengths, and can be numerically broken down into a series of sinusoids using Fourier analysis. In a gravitational survey, shorter wavelengths will be preferentially attenuated according to equation (1).

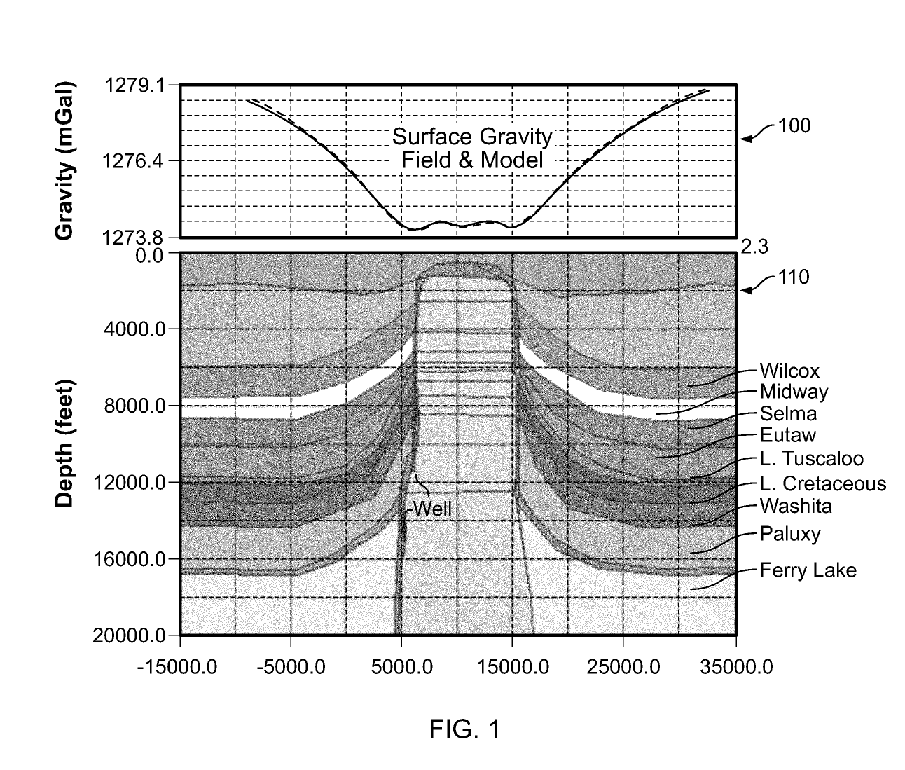

The resolution of a geophysical method is determined by the size and wavelength of structures that it can detect, and how well it can determine source parameters such as the structure thickness. FIG. 1 shows an example of a salt dome structure with a large, broad gravity anomaly upon which are superimposed smaller “ripples” of wavelength about 2500 feet. FIG. 1 shows gravity data 100 and depth data 110 recorded near the cap of the salt dome. The depth above the source determines the ideal resolution limit of gravity measurements, with practical limitations being also determined by the noise floor of the measurement and the spatial sampling of the measurements. Thus, for marine gravity measurements, higher resolution can be achieved by 1) sampling closer to the ocean floor, 2) increasing the sampling rate, and 3) reducing the sensor noise. The AUV-borne gravimeter system as described in this specification can achieve a higher resolution than current surface gravity and surface gradiometer surveys, at a roughly equivalent cost and coverage rate.

Platforms for On-Bottom or Near-Bottom Gravity Surveys

Submersibles have been used for gravity measurements on the seafloor in many instances. Holmes and Johnson [1993], Evans [1996], Pruis and Johnson [1998], and Ballu et al. [1998] used land gravimeters inside the personnel sphere of a submersible to profile gravity variations across a seafloor feature. The expense and short duration of dives with manned submersibles limits the spatial coverage.

Also, underway gravity data can be obtained using an underway submersible. For example, vertical gravity profiles have been obtained from within Sea Cliff using a Bell BGM-3 marine gravimeter [Zumberge et al., 1991]. A resolution of order 0.1 to 0.2 mGal can be achieved. In addition, Cochran et al. [1999] used a BGM-3 in the DSV Alvin to survey horizontal profiles across the East Pacific Rise. The BGM-3 is a gyro-stabilized accelerometer commonly used for surface ship gravity surveys. The resolution is estimated to be 0.3 mGal by comparing g values measured while transiting over seafloor markers with g values obtained while remaining stationary on the sea floor at the markers. While the precision from underway submersible observations is not as good as that for on-bottom measurements (estimated to be around 0.1 mGal by Holmes and Johnson [1993], and shown to be as good as 0.01 mGal in the North Sea surveys), the coverage is better. However, the underway submersible is still limited by dive duration.

A towed deep-ocean gravimeter (TOWDOG) is designed for near-seafloor gravity surveys with continuous operation [Zumberge et al., 1997]. The gravity meter is towed 25 to 100 meters above the seafloor at a speed of 1.5 knots (0.77 m/s) and can operate for days at a time. The gravity meter was partially decoupled from the heave of the ship by the geometry of the towing system. Precision can ranged from 0.2 mGal to 1.0 mGal, depending on the quality of ship control during the survey and the depth of the survey tracks.

In one example, a 350 kg TOWDOG consists of a double pressure case that holds a LaCoste & Romberg shipboard gravimeter mounted on a gyro-stabilized platform, accompanying electronics, an on-board computer, tilt meters, a compass, and a pressure gauge. Acoustic transponders provide precise navigation for the package. The vertical position of the instrument is determined by recording pressure with a paroscientific pressure sensor and converting to a depth estimate using a seawater density profile. This is used to calculate vertical accelerations of the meter, as well as the free-water gravity correction.

The TOWDOG instrument has been used in four deep-towed gravity survey: 1) over the San Diego Trough (a sedimentary basin) in November 1995; 2) over the Emery Knoll in May 1996; 3) over the Bent Hill sulfide mound off the Juan de Fuca Ridge in August, 1998, and 4) over the Alarcon mid-oceanic spreading center in October 1998. On the San Diego Trough survey, track lines were collocated across a 2D fault structure with an RMS repeatability of 0.6 mGal when full tracks (with biases removed) were compared, and less than 0.3 mGal when comparing sections of 3 km length [Zumberge et al., 1997]. The survey was designed to measure the near-surface density structure across the fault central to the Trough.

Emery Knoll is a nearly circular seamount-like structure offshore San Diego, Calif., near San Clemente Island. It is about 14 km in diameter and rises 500 meters above the surrounding flat seafloor. A deep-towed gravity survey was conducted to determine the fine scale density structure of the knoll, which yielded a grid of nine track lines with concentrated measurements around the knoll's peak.

Crossover analysis yielded an RMS error between tracks of 0.85 mGal after removal of biases. Forward modeling of the towed data was carried out using a version of the Parker [1995] terrain correction code. The model is constrained by Seabeam bathymetric data and multichannel seismic reflection profiles, which reveal that sedimentary basins 1.2 to 1.6 km deep surround the knoll. A simple division of the model into dense (2800 kg/m³) homogeneous basement rock and infilling sediments can satisfy the data to about a 1.4 mGal RMS level; the addition of a massive intrusive body near the knoll's peak results in a match to the data of about 1 mGal. Ridgway and Zumberge [2003] describe this work.

The Bent Hill sulfide mound is located in the heavily sedimented Middle Valley, which is just east of the Juan de Fuca Ridge. It is a hydrothermal deposit approximately 100 meters in diameter, which was formed by the channeling of mineral-rich fluids through faulted cracks, themselves caused by an intrusive sill underneath Bent Hill [Rohr and Schmidt, 1994]. The towed survey yielded numerous gravity and magnetic tracks passing over Bent Hill, as well as swath bathymetry, deep-sonar and CTD data [Ridgway et al., 1998; Gee et al., 2001]. In addition, several exploratory tracks were carried out over the Dead Dog hydrothermal field and other mounds to the north. Although a substantial number of gravity tracks are noisy because of a platform malfunction, several good ones are obtained over Bent Hill. These gravity tracks show a positive gravity anomaly of 2 to 4 mGal over the sulfide mound. The mound also produces an intense, isolated magnetic anomaly of several hundred nT recorded by the deep-towed magnetometer, which yields a depth estimate and geometry of the sulfide body consistent with other data [Tivey, 1994; Goodfellow and Peter, 1994]. The TOWDOG together with a deep-towed magnetometer provides a combination for investigating large sulfide mounds.

While useful for above purposes, the TOWDOG system is limited by various reasons. For example, for the surveys performed in deeper water, the noise in the gravimeter increased. This increase in noise may be due to the increased noise in the towed vehicle's track as more cable is dragged through the water column. Controlling the depth to a few meters becomes difficult when the cable is several km in length and the ship speed varies with wind and current. Also, the surveys using TOWDOG are performed fairly slowly, and a large ship must be dedicated to the task. These two limitations can be remedied by implementing an AUV survey as described in this specification rather than a towed survey method.

A Remotely Operated Vehicle Deep Ocean Gravimeter (ROVDOG) is an instrument for use in sea floor gravity observations [Sasagawa et al., 2003]. A remotely operated vehicle is used to transport and position the gravimeter, which is mounted inside a pressure case 30 cm in diameter and 49 cm high. A Scintrex CG-5 gravimeter sensor is used in the instrument, and motorized gimbals within the pressure case level the sensor. A precise quartz pressure gauge provides depth information. A small microcontroller executes various system functions and provides communications to the surface. An operator can control the instrument via an RS-232 link to the ROV, and view and record the data stream. Repeatability ranges from 0.005 to 0.010 mGal. This resolution is an improvement over measurements taken from within a submersible because the instrument, being external to the vehicle, can be decoupled from vehicle motions. ROVDOG can be used to monitor gravity changes caused by fluid withdrawal from a large undersea hydrocarbon reservoir [Eiken et al., 2000]. In addition, ROVDOG has been used to conduct a survey to monitor carbon dioxide migration in a carbon sequestration pilot project (www.ieagreen.org.uklsacs2.htm).

A variant of ROVDOG was constructed (NSF OCE 9618325) with an operating depth in excess of 4500 meters. It is compatible for deployment with manned submersibles as well as a variety of ROVs. This instrument was used on a survey of the Mid-Atlantic Ridge in 2000, using Alvin [Nooner et al., 2003]. Ballu and Sasagawa have used a ROVDOG to surveys the Lucky Strike seamount on the mid-Atlantic ridge, including high-resolution spatial surveys and time-lapse deformation monitoring.

AUV Implementation:

The techniques and systems described in this specification implement a gravity meter incorporated into an AUV. The AUV implementation as described in this specification provides various advantages over the submerged and towed systems described above. For example, the underway motions of an AUV are small enough so as to allow recording and correcting for the vehicle tilts rather than gyroscopically eliminating the vehicle tilts. This can provide a higher precision for an AUV gravity survey than a tethered system. Also, the ability to correct for the small vehicle tilts reduces the need to incorporate a gyroscopic apparatus as is done on a shipboard gravity meter, and thus power and space requires are reduced.

In some implementations, a gyro-stabilization can be incorporated into the sensor payload of an AUV. Because of the small motions of the AUV, the gyro stabilization can be simplified, made smaller and designed to use low power in comparison to the shipboard gyroscopic sensor.

In addition, for a towed survey, a large ship is tethered to the gravity sensing system. However, in an AUV survey system, a much smaller ship can be used, and the ship can be available for other scientific investigations during the gravity survey independent of the AUV. An AUV can travel faster and make tighter turns than a towed vehicle, resulting in more complete and efficient coverage.

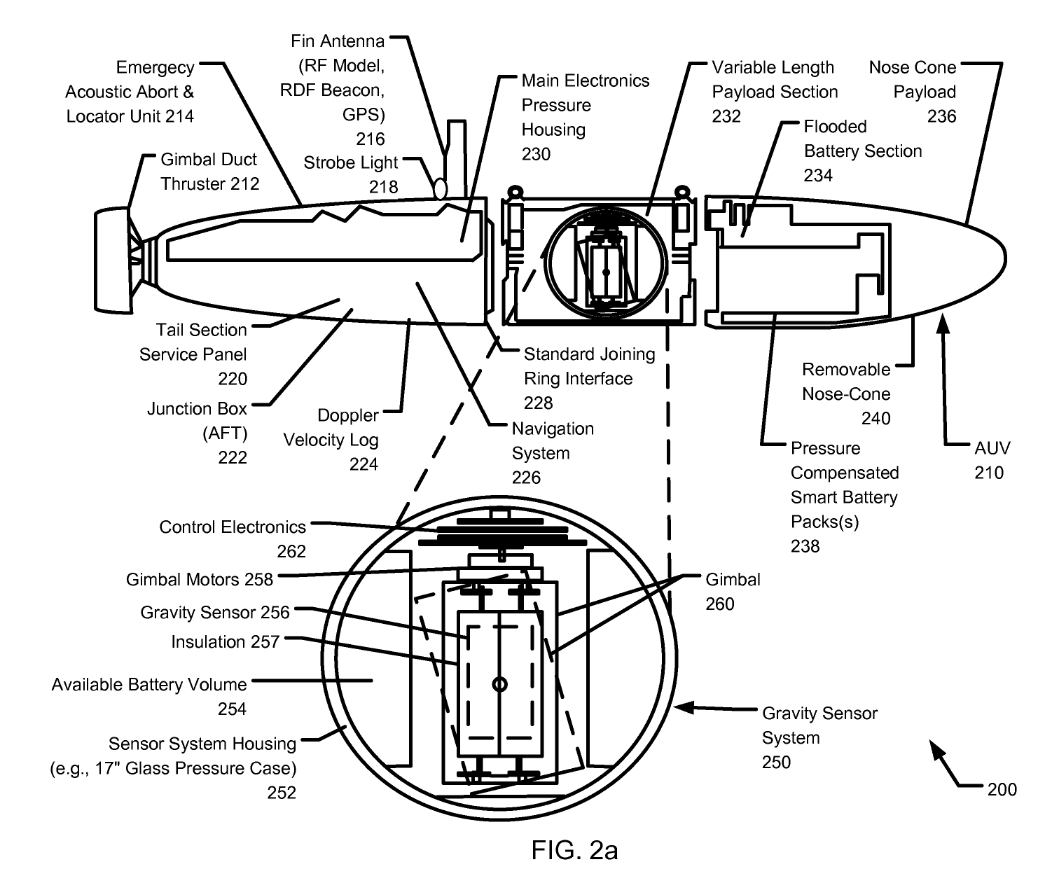

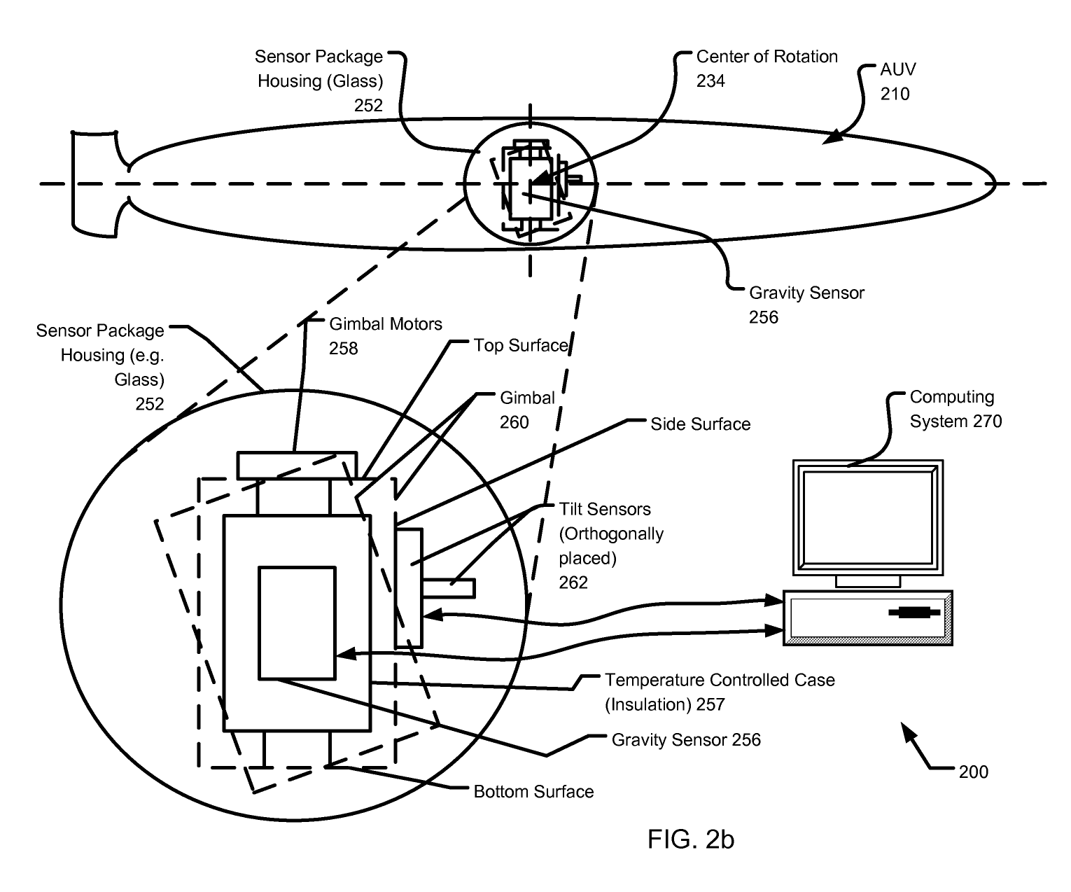

FIGS. 2a and 2b show an example AUV-borne gravimeter system. The system 200 includes an AUV 210, such as the Bluefin 21 vehicle with a gravimeter sensor system 250 as a payload. The aft section of the AUV 210 includes propulsion systems and vehicle control electronics. For example, the AUV 210 can include, in the aft section, a gimbal duct thruster 212, a emergency acoustic abort & locator unit 214, a fin antenna (e.g., RF model, RDF beacon, GPS, etc.) 216, a strobe light 218, a tail section service panel 220, an aft junction box 222, a doppler velocity log 224, a navigation system 226, a standard joining ring interface 228 and a main electronics pressure housing 230.

The forward section of the AUV can include a flooded battery section 234 that contains a battery pack, such as pressure compensated lithium ion battery packs. Also, the forward section can includes a nose cone payload 236, a pressure compensated smart battery pack(s) 238, and a removable nose-cone 240. The midsection of the AUV 210 can include a variable length payload section 232 to hold a mission-specific payload, such as a gravity sensor system 250.

FIG. 2a shows a scale drawing of a gravity sensor system 250 superimposed on the AUV 210, and a larger drawing detailing the individual components of the gravity sensor system 250. The gravity sensor system 250 can include a sensor system housing 252, such as a glass pressure case of various thicknesses (e.g., 17 inch glass). The gravity sensor system 250 includes an available battery volume 254 to power the gravity sensor system 250. A gravity sensor (or gravimeter sensor) 256 and insulation unit 257 are attached to a gimbal 260. The gimbal is connected to a gimbal motor 258 to maintain the gravimeter at a leveled configuration. The gravity sensor system 250 includes control electronics 262 to control operation of the system to maintain a leveled sensor platform for the gravity sensor 256.

The torpedo-shaped AUV can be implemented using a Bluefin 21 vehicle that is 2.5-5.0 m in length (depending on the payload module), 0.58 m in diameter, and weighs 150 kg without a payload. A standard 17″ (43 cm) diameter glass sphere can be implemented in the aft fairing to contain the vehicle control electronics. A pressure compensated rechargeable lithium-ion battery pack can be placed in the forward fairing. A variable length mid-section can contain the sensor payload, the gravity sensor system 250. A 17″ diameter glass sphere can be used as the sensor system housing 252, for example. The vehicle is rated for a depth of 3000 m with a maximum speed of 4 knots. Endurance is function of speed, payload needs and battery capacity. The battery pack can sustain a 52 hour mission at 1 knot. Navigation can be provided by a combination of dead reckoning, acoustic positioning, and an onboard Inertial Navigation System (INS).

Examples of AUVs include the Bluefin 21 series of AUVs developed at the MIT Sea Grant Laboratory in the 1980s. From these developments, BlueFin Robotics (www.bluefinrobotics.com) emerged as a commercial spin-off that would then produce the “Bluefin 21” used in this application. A Bluefin 21 AUV was funded by the Defense University Research Instrumentation Program (DURIP) for use by the Marine Physical Laboratory (MPL) at Scripps Institution of Oceanography (the PI is Dr. Gerald D′Spain of Scripps), etc. Using such AUVs and various gravity sensors, an existing seafloor gravimeter can be modified for use as an underway system. In addition, the underway gravity system can be installed in an instrument system, such as the 17″ (43 cm) glass instrument sphere. The gravimeter system incorporated into the AUV can be implemented to determine the resolution and noise of the gravity data recorded.

The sensor payload that includes a gravimeter sensor system 250 can be designed to fit inside the sensor housing (i.e., the 17″ glass sphere) of the AUV. The glass sensor housing is held in place inside the variable length payload section 232 of the AUV by attaching it to an internal wall, ceiling, floor or combination of the AUV 210. The payload section 232 can be flooded with water to provide depth control for the AUV 210. The sensor housing 252 is structured to provide positive buoyancy to the sensor system. The gravimeter sensor system 250 can include a motorized gimbal 260 and 258 to provide a leveled sensor platform. A gravimeter sensor 256 can be mounted onto the motorized gimbal 260 and 258 to measure gravity data. Also, one or more motion sensors, such as tilt sensors 262 can be mounted onto the motorized gimbal to measure the motion data, such as tilt data associated with movements of the autonomous underwater vehicle. For example, two tilt sensors 262 can be orthogonally placed on a side surface of the gimbal. Additionally, the tilt sensors 262 can be placed on a top surface (near the gimbal motors) or a bottom surface of the gimbal to measure the tilt measurements of the gravity sensor system. Additionally, the AUV-borne gravimeter system can communicate with a computing system 270 to communicate with the components of the gravity sensor system 250, such as the gravimeter sensor 256 and the tilt sensor(s) 262. The computing system 270 can receive and process the recorded gravity data from the gravity sensor 256 and the tilt data from the tilt sensors 262. Based on the received tilt data, the gravity data is modified to correct for the undesired effects of the tilting motion of the AUV.

FIG. 2b shows another representation of a gravity sensor system. As described above, the gravity sensor system 250 can be placed in the payload section of the AUV 210. The gravity sensor system 250 can include a sensor package housing (e.g., a glass sphere) 252, a gimbal 260, a gimbal motor 258, at least two tilt sensors 262, a gravity sensor 256, and a insulating unit, such as a temperature controlled casing 257 to insulate the gravity sensor 256. The gravity sensor 256 can be encapsulated inside the temperature controlled casing 257 to protect the gravity sensor from temperature fluctuations. The gravity sensor 256 can be indirectly mounted to the motorized gimbal 258 and 260 through the temperature controlled casing. The dotted-lined rectangles show possible tilting motion of the gimbal 260 that counterbalances the tilting motions of the AUV 210. The gravity sensor system 250 can communicate with a computing system 270 to communicate the recorded gravity and tilt data.

The sensor package housing 252, such as the glass sphere can encapsulate the components of the gravity sensor system 250 and provide buoyancy of the sensor package. The components of the gravity sensor system 250 encapsulated in the sensor package housing 252 includes the gimbal 260 attached to the gimbal motor 258. The gimbal 260 is attached to the gimbal motor 222 to provide active motion compensation to the gravity sensor 256 located inside the temperature controlled casing 257. The temperature controlled casing 257 is attached to the motorized 258 gimbal 260 to control movement of the gravity sensor 256 inside the temperature controlled casing 257. The gravity sensor 256 can be temperature sensitive and thus the temperature controlled casing 228 can insulate the gravity sensor 256 to provide a temperature controlled gravity sensor system.

The motion of the AUV 210 is translated to the gravity sensor. To at least partially negate or compensate for the effects of the AUV 210 movement, the motorized 258 gimbal 260 can provide active motion compensation by moving the gimbal 260 in such as way to negate the movement of the AUV 210. For example, when the AUV 210 tilts forward, the motorized 258 gimbal 260 can actively move in the opposite direction to keep the attached gravity sensor 262 leveled. Additionally, the motorized 258 gimbal 260 can be used to perform active compensation of low frequency noise due to the motion of the AUV 210.

In addition, tilt sensor 262 can be placed at or near the gimbal 260 to provide additional tilt data. For example, two orthogonally positioned tilt sensors 262 can be attached to a side surface of the gimbal 260. The tilt data obtained from the tilt sensor 262 can be used to further compensate or correct the gravity data received from the gravity sensor 256 by using off-line processing of the received data. Two tilt sensors 262 can be positioned orthogonal to each other and placed on the gimbal 260 to detect angular motions such as pitch and roll of the AUV 210. The motion data from the tilt sensors 226 can be used to compensate or eliminate high frequency noise due to the motion of the AUV 210.

Examples of tilt sensors include accelerometers and electrolytic tilt sensors that use a precise level vial and measure the position of a bubble in the vial electronically. The electrolytic tilt sensor is similar to a carpenter's level.

The gravity sensor 256 and the tilt sensors 262 can be placed at or near the center of rotation 234 of the AUV 210. By placing the gravity sensor 256 and the tilt sensors 262 near the center of rotation 234 of the AUV 210, the movement of the gravity sensor 256 and the tilt sensors 262 are minimized along each axis.

In some implementations, a gyroscopic sensor is implemented in addition to or in place of the tilt sensors. The gyroscopic sensor detects rate of motion of the AUV and integrates that rate of motion information to get absolute pitch and roll. The tilt sensors can be used to compensate for drift in the gyroscopic sensor.

In some implementations, the gyroscopic sensor of the AUV itself can be used to obtain motion data.

The AUV-Borne Gravimeter Sensor Design

The AUV-borne gravimeter sensor system 250 can provide higher resolution surveys at a small fraction of the cost associated with a towed survey. The gravimeter sensor system 250 can include a gravity survey instrument with a target precision of 0.1 mGal (1 Gal≡1 cm·s⁻²), for example. The list of gravimeters capable of collecting data while underway in the marine environment is short, and commercial instruments are much too large and require more power than can be provided by an AUV.

For example, the gravity sensor system 250 can fit into the limited payload bay of an AUV, such as the Bluefin 21 series AUV. Also, the gravity sensor system 250 can operate with limited power. The power and space requirements of a shipboard gravity meter prohibit incorporating such shipboard gravity meter into an AUV. Thus, the gravity sensor system 250 provides a unique gravimeter design for the AUV environment. Example gravimeters that can be modified include a LaCoste & Romberg S-meter system and a Bell BGM-3 system. These and other similar sensor systems are not designed to meet the power and size requirements of the AUV environment. Thus, these sensors are modified to meet such requirements. For example, the LaCoste & Romberg S-meter system and a Bell BGM-3 system can be modified to operate with power of order 100 watts and fit in a spherical volume with at least a 22″ ID.

Examples of gravimeters that can be incorporated into an AUV without modification include the sensor from a Scintrex CG-3 land gravimeter. The sensors from the Scintrex CG-3 land gravimeter can be mounted on a simple gimbal to collect gravity data aboard an AUV (www.scintrexltd.com). Applicability of the CG-3 sensors can be validated using laboratory tests and on-motion data provided by third party entities, such as J. Bellingham (private comm., 1998).

In some implementations, the existing gimbal and sensor package of ROVDOG can be modified to fit into a 17″ glass sphere. For example, the gravity sensor system 250 shown in the scaled diagrams of FIGS. 2a and 2b can be implemented using a modified Scintrex CG3 sensor and associated gimbal actuators and control electronics fitted into a spherical sensor housing. The completed instrument can be made positively buoyant using the glass housing. For example, the glass housing can provide 250 Newton (56 lbs) of positive buoyancy. Data recording and instrument power can be provided by the AUV itself. The ROVDOG sensor requires about 24 W, only 5% of the Bluefin 21 battery capacity, for example. Glass spheres are ideal for underwater systems, due to their low cost and weight.

The CG-3 sensor is robust. The ROV based system using the CG-3 sensor can be launched and recovered more than 100 times during North Sea surveys with no instrument problems. The CG-3 sensor also has a large dynamic range. Integration of the sensor into a gimbal package can be implemented using the techniques used for the ROVDOG system. While the gravity sensor system 250 shown in FIGS. 2a and 2b is described with respect to the Scintrex CG-3 sensor, other similar sensors can be implemented.

When integrating the sensor package into an AUV, such as the Bluefin 21 vehicle, the added weight and inertia of the sensor package can be analyzed by the Marine Physical Lab (MPL) to determine the affects on the Bluefin 21 vehicle's dynamics. Also, the MPL personnel can design power and data logging for this instrument, using the AUV systems. Mission planning and vehicle programming can also be performed by MPL engineers.

AUV-Borne Gravimeter System Characteristics

The AUV-borne gravimeter system 250 described herein can address platform and sensor induced gravity measurement errors. Specifically, potential sources of error in the gravity data recorded can include:

1) Removal of vertical acceleration noise to achieve the total root-mean-square (RMS) noise floor goal (0.1 mGal rms from DC to 10 milli-Hz);
2) Sensor vertical alignment; and
3) Noise due to lateral accelerations (which can be misinterpreted as tilts).

These three errors are closely interrelated, as all include gravity data error reduction. The raw gravity readings can be corrected using equation 3 (from Zumberge et al., 1997):

g_{fw}=g₀−γ_{w}Δz−g_{φ}+\ddot{z}−g_{E}−gₜ (3)

where g_{fw} is the final, “free water” gravity, g₀ is the raw gravity, γ_{w} is the free-water gradient of gravity (0.223 mGal/m), Δz is the height above a reference elevation, 2 is the vertical acceleration of the platform body, g_{E} is the Eötvös effect caused by the platform horizontal velocity, g_{φ} is the latitudinal effect on the gravity field, and gₜ is the effect of the oceanic and solid earth tides.

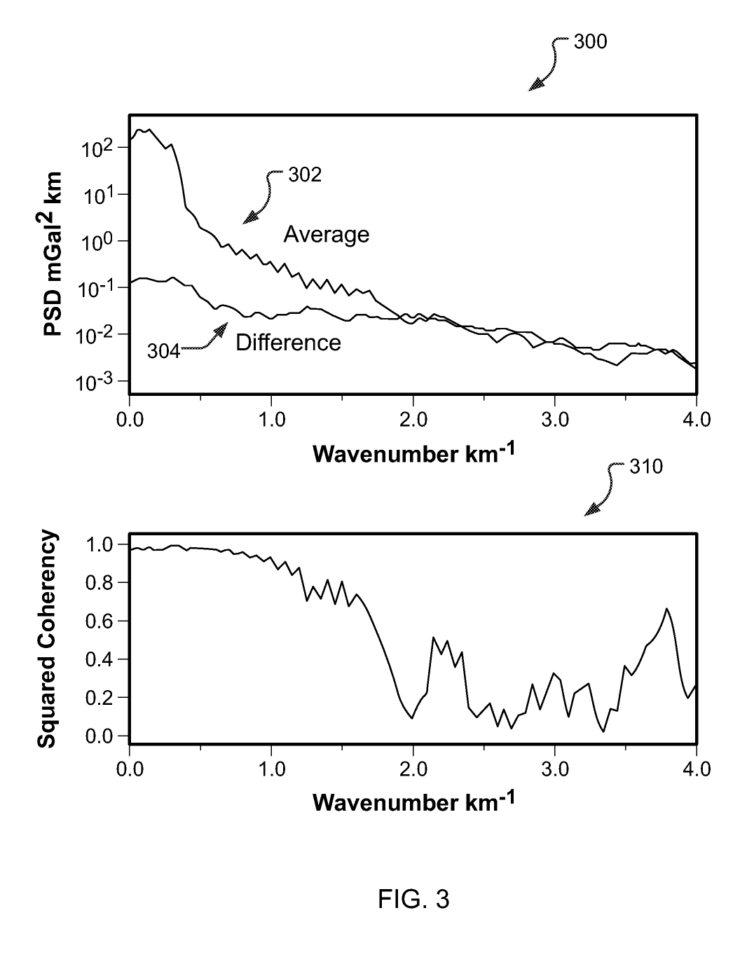

The relative contributions to gravity measurement error from the above potential sources are quantified. FIG. 3 shows example signal spectra 300 collected by a towed system (e.g., TOWDOG) and squared coherence 310 between co-located tracks. (Reproduced from Zumberge et al., 1997). In FIG. 3, the TOWDOG traversed a 12 km track line at a depth of 1100 m several times. Spectra of the gravity records are computed and stacked, and the result is shown in the trace in the upper plot 300 of FIG. 3 labeled, Average 302. Gravity records are then split into two sets, each averaged, and the spectrum of the differences computed. This is labeled “Difference” 304 in the power spectrum shown in FIG. 3. The trace labeled, Difference, represents an approximation of the system noise floor for a towed vehicle and indicative of the noise spectrum of the technique. This is confirmed by the coherency computed in the lower plot 310 of FIG. 3. At wavelengths shorter than about 500 m (or wavenumber greater than 2 km⁻¹), the noise floor of the sensor is encountered. This occurred at a power of 4×10⁻² mGal²km, or about 0.2-mGal amplitude at 500 m wavelength. The tow speed varied between 1 and 2 knots, corresponding to a time scale of about 500 seconds. The data are low-pass filtered with a corner frequency of 3.3 milli-Hz (300 seconds filter length). The TOWDOG can resolve gravity changes of a few tenths of a mGal at time scales greater than several hundred seconds and/or wavelengths longer than several hundred meters. This noise estimate takes into account all of the noise sources summed together in the band from DC to 4 km⁻¹. Also, given low-noise measurements on the AUV platform, a shorter low-pass filter can be used to gain resolution at higher frequencies, up to 10 milli-Hz (100 seconds filter length).

The noise level recorded for the TOWDOG can be improved by using a vehicle with smoother motion, such as an AUV. Modern spring-mass gravity measuring technology on land can achieve a resolution of a few thousandths of a mGal in a few minutes. Therefore, the noise encountered by an underwater sensor is not due to imperfections in the gravity meter, but rather the noise comes from other accelerations encountered by the sensor while moving. To improve the noise, these other vehicle accelerations can be addressed.

A noise source in the measurement of gravity data on a moving platform includes vertical accelerations. The vertical height below sea level is measured by a pressure gauge, which converts to depth via a known seawater density profile. Depth is converted to vertical acceleration \ddot{z} by numerically differentiating the height, and differenced with the gravity measurement, which contains both \ddot{z} and the geologic information for isolation.

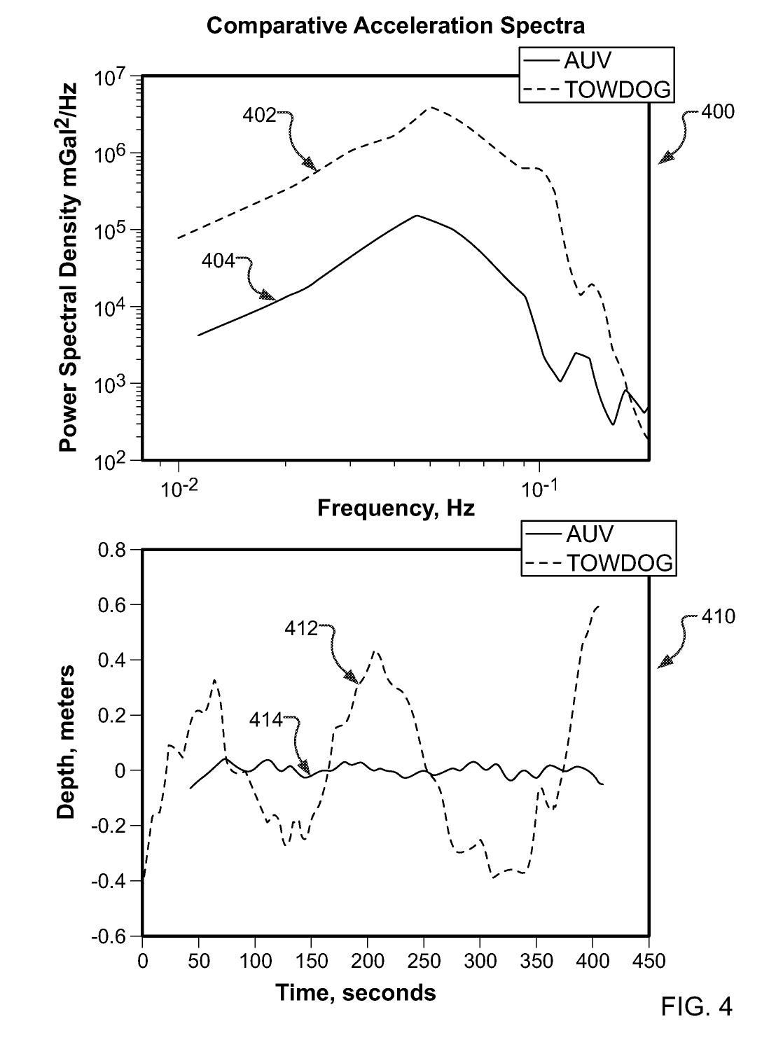

Navigation records from the TOWDOG and from a Bluefin 21 AUV can be used to compute vertical acceleration from pressure as described above. FIG. 4 shows example vertical acceleration spectra 400, 402, 404 and accompanying depth time series 410, 412, 414 for a towed vehicle (dashed curve) and an AUV (solid curve). The acceleration spectra for AUV and TOWDOG are displayed as 402 and 404 respectively. The corresponding depth data for AUV and TOWDOG are displayed as 412 and 414 respectively. The maximum in the spectra is artificial and caused by application of a 20-second low-pass filter window to each time series before taking the power spectra. The vertical accelerations undergone by the AUV (402) are some 15 dB lower than those encountered by the towed vehicle (404). The likely cause of noise in the TOWDOG is from varying drag forces on the tow cable, which worsened as depth increased. The AUV has no tow cable to perturb it. The 15 dB decrease in vertical acceleration noise gained by observing from an autonomous vehicle rather than a towed one translates directly to an improvement in underwater gravity resolution. Because this significant decrease in vertical acceleration noise is realized in going from a towed vehicle to an autonomous one, and the gravity noise is primarily due to the vehicle's vertical motion. Due to the 15 dB improvement in the gravity noise, an AUV-borne gravity meter can resolve gravity signals of less than 0.1 mGal in the band from near-DC to 10 milliHz, which are equivalent to wavelengths longer than 250 m for a 5-knot survey speed).

Additional components can be implanted to achieve the superior noise level. For example, improved acceleration-reduction software based on an adaptive RLS algorithm (Vorobyov, 2001) can be used to match and remove the ‘reference’ pressure-derived signal much more effectively from the measured gravity than the previous method of simple scaling and subtraction.

Another source of noise is misalignment of the gravity sensor from vertical. A shipboard gravimeter sensor needs to average out the large vertical accelerations. Onboard a ship, the gravimeter sensor experiences accelerations of up to a few hundred Gal or a few tenths of a g (g is around 980 Gal) and the desired sensitivity is a fraction of a mGal, or 10⁻⁵ of the noise. The shipboard gravimeter sensors should have a linear response and wide dynamic range to average out or filter away the noise, which is entirely out of the band of interest. However, this is not a problem aboard an AUV because the accelerations associated with the vehicle vertical motion is only a few tens of mGal.

Also, the shipboard gravimeter needs to keep the sensor aligned with the vertical. Tilt meters have the requisite precision to maintain vertical such that the error Δg from misalignment is less that 0.1 mGal. In a typical power-hungry shipboard platform, this is addressed using two gyroscopes, two accelerometers (tilt meters), and servomotors. By contrast, the AUV-borne gravimeter system described in this specification uses compact, low-power tilt meters having precision to maintain vertical orientation such that the error Δg from misalignment is less that 0.1 mGal. Being a cosine error, the technical characteristics include a factor such that ½ θ²<Δg/g where θ is the angle between the sensor's sensitive axis and the vertical. For Δg to be no more than 0.1 mGal, the tilt θ should be less than 0.5 mrad or about 0.03°. This can be measured using electrolytic tilt sensors and removed in post processing using the computing system, for example.

Tilt sensors are affected both by tilt and by horizontal acceleration. On a ship, this is overcome by incorporating gyroscopes into the system. However, such gyroscopes are sensitive only to rotation, not horizontal acceleration. Combined with tilt sensors, which find the average vertical, a stabilized platform slaved to gyroscope signals will remain vertically aligned to better than 0.03° in an environment which is rolling by ±30°.

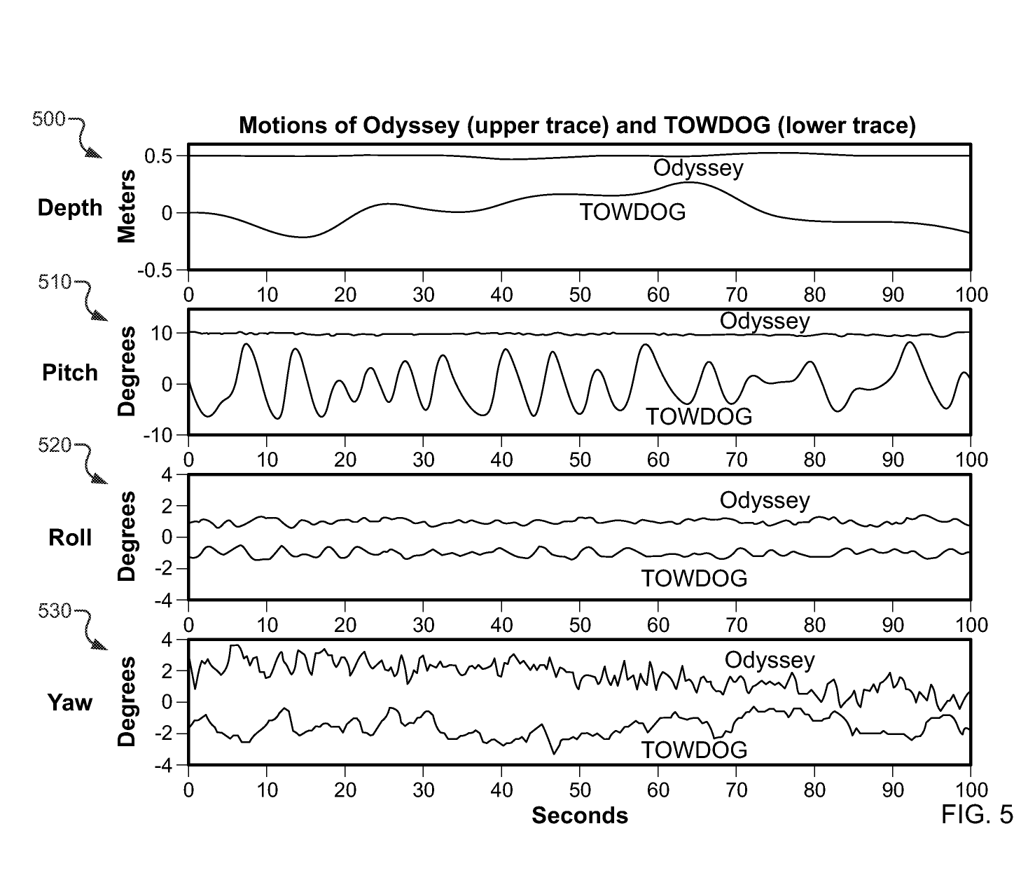

FIG. 5 shows a comparison of vehicle motions between a Bluefin 21 vehicle and TOWDOG. The Bluefin 21 data shows results of a Bluefin 21 test deployment in which roll 520, pitch 510, yaw 530, depth 500, and a number of other parameters were recorded. Time series of the roll, pitch, yaw and depth data for the Bluefin 21 vehicle are compared with similar time series data recorded during a TOWDOG survey. The TOWDOG acceleration noise is much larger than the acceleration noise of the Bluefin 21. An AUV gravity sensor may experience only 20% of the TOWDOG depth deviations and 10% of the TOWDOG pitch deviations. Also, the turns on the track line ends are quite short. A towed system with several km of wire attached must travel several kilometers to make a turn.

As shown in FIG. 5, the TOWDOG motion is much less than that of a ship. The AUV motions are smaller still. The effects on the gravity record from AUV rotations (a few tenths of a degree) will be of order 10 mGal. To record and apply as correction signals to the gravity data, the tilt records are designed to be precise to about 1% to achieve a corrected gravity precision of 0.1 mGal. Vertical accelerations, which (in the band of interest) are about a factor of 10 smaller than in TOWDOG, can be removed by pressure measurements.

The greatly reduced pitch and roll of an AUV can eliminate the need for a gyro-stabilized instrument platform. Rather, a simple tilt-meter leveled platform carrying a wide-dynamic range sensor can be substituted to perform tilt compensation. The small size and low power consumption of such a system is compatible with the payload requirements of an AUV.

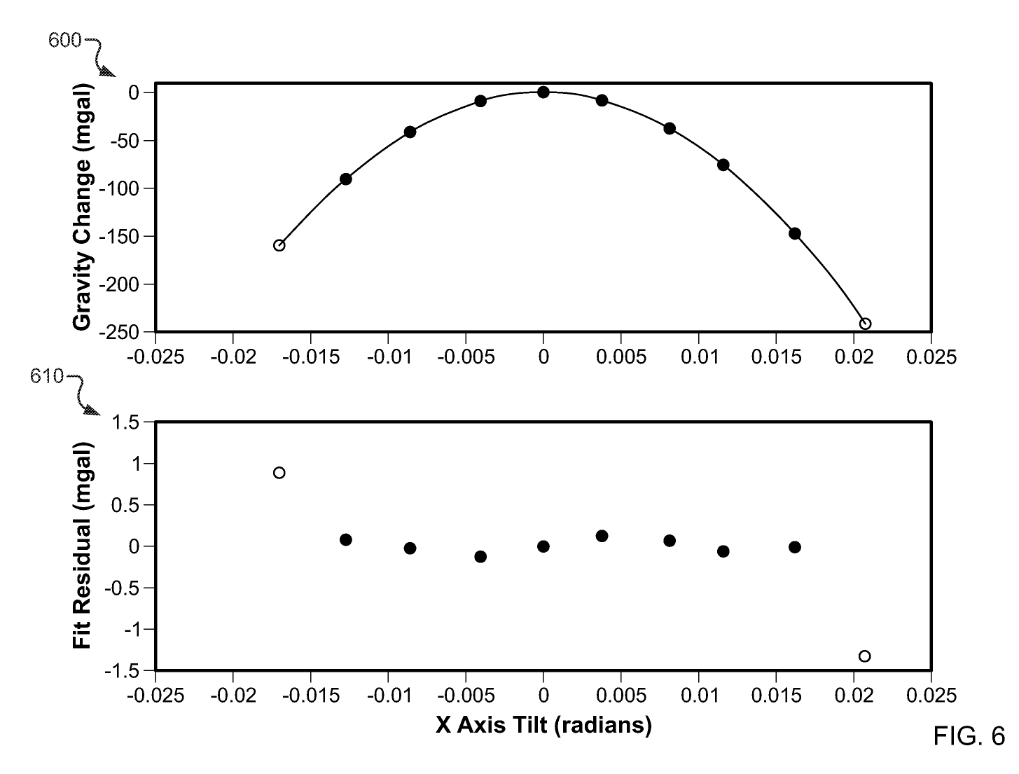

FIG. 6 shows an example of gravity change 600 observed with offset angle from vertical and corresponding fit residual data 610. The correction based on a simple electrolytic tilt sensor is correct within 0.1 mGal for tilt ranges up to ±1°.

Data from ROVDOG shows that the sensor response is predictable over relatively large tilt angles. The sensor is rotated from vertical over a ±1° range and the apparent gravity reading decrease is corrected with angular information from a simple tilt meter or tilt sensor mounted on the gimbal frame (e.g., Applied Geomechanics 900 series tilt meter, with 0.01° resolution over a 20° range). The residual RMS error is within 0.09 mGal.

Referring back to FIG. 5, ±1° is shown to be about the maximum tilt deviation expected during an AUV track. If the gravimeter is leveled at the beginning of each track, then pitch and roll during the track line can simply be measured and removed in post-processing (along with the Eotvos correction produced by the vehicle's component of east-west velocity). Because the tilt deviation can be measured and removed in post-processing, a gyro-stabilized platform may not always be needed in the AUV-borne gravimeter. In some implementations, it may be desirable to include a gyro-stabilized platform.

Another source of noise for a gyro-free system includes contribution from lateral or horizontal acceleration of the AUV in the recorded gravity data. To prevent misinterpretation of lateral accelerations as rotations of a problematic amplitude, the lateral accelerations should typically be less than the order of 0.5 Gal (a lateral acceleration ‘a’ appears as a tilt of a/g; for a=0.5 Gal, the apparent tilt is 0.5 mrad which induces a 0.1 mGal error). A 0.5 Gal lateral acceleration accumulates to an off-track navigational error of 0.25 m in 10 seconds and 1 m in 20 seconds.

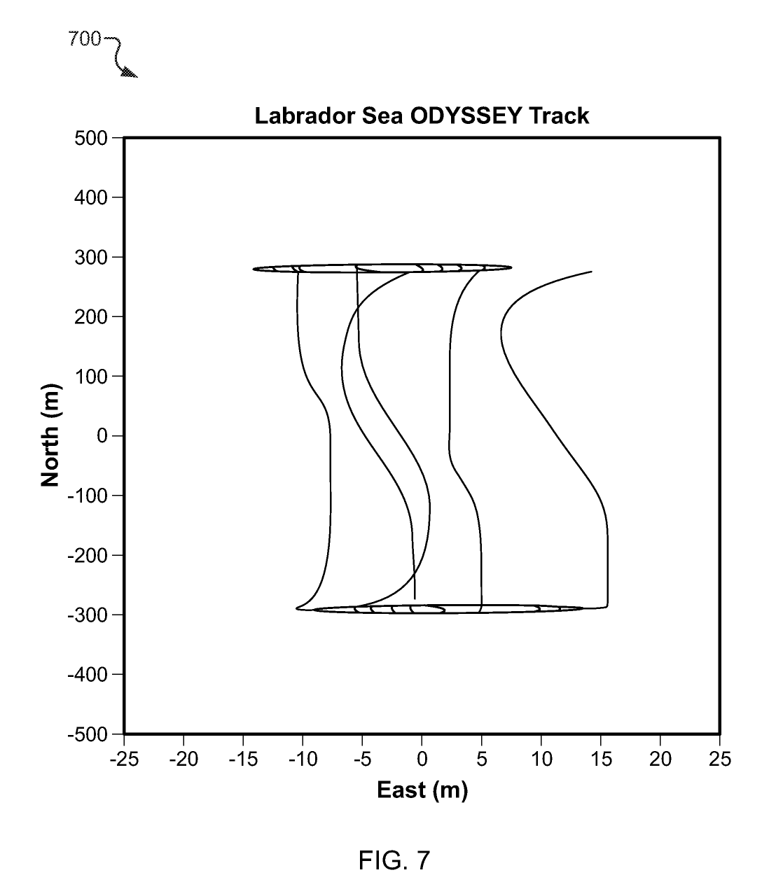

FIG. 7 shows example navigation tracks 700 from a deployment of an AUV, such as a Bluefin 21 vehicle. During the deployment, the AUV spirals down to a series of depths and travels along a straight track at each one. The horizontal scale is expanded by a factor of about 20 to accentuate cross track motions. Data provided by J. Bellingham (private comm., 1998). Calculations of lateral accelerations from these x-y positions indicate typical amplitudes of a few tenths of a Gal, indicating that horizontal motions will not cause a problem with a gyro-less system.

As described above, the AUV-borne gravimeter system includes a leveling system that includes a gravity sensor mounted in a motorized gimbaled frame. The leveling system is gradually kept in alignment with the vertical while tilt meters record the instantaneous deviation from vertical for later correction. An underway gimbal alignment system such as the one developed at SIO can be implemented (Sasagawa et al., 2003).

Yet another possible source of error is the presence of on-bottom bathymetric features. For example, a Bluefin AUV has a downward-looking sonar that can log bathymetry directly under the AUV tracks, and the support ship can contribute with simultaneous swath bathymetry, which is utilized in post-processing to remove the bathymetric gravity effects. Also, proper placement of the AUV sufficiently above the bottom can diminish this source of error while retaining the gravity resolution on the target subsurface structures.

With the removal of the need for a stabilized platform, the power and space requirements of a land gravimeter are reduced to the level where it is feasible to install it in an AUV. The system will consist of a gravity sensor mounted in a motorized gimbal frame that will be gradually kept in alignment with the vertical while tilt meters record the instantaneous deviation from vertical for later correction. Much of the job is in signal processing—appropriately filtering the data records to minimize the corrected residuals.

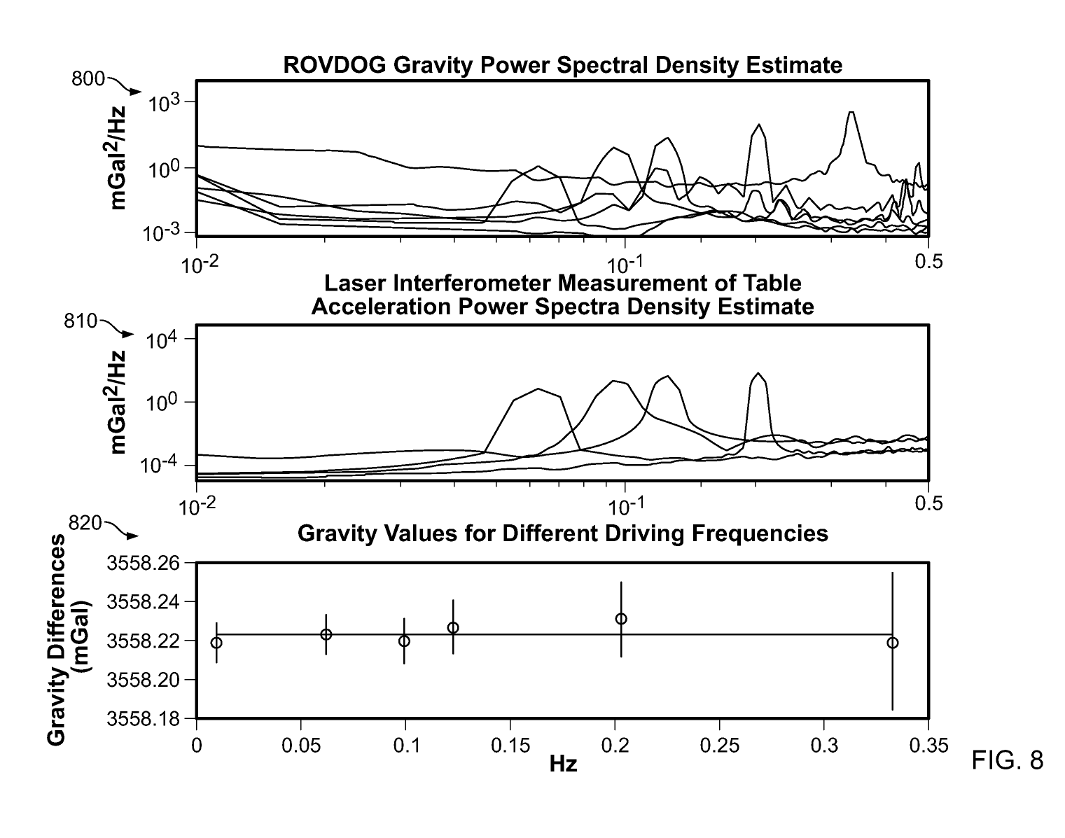

In addition to the tilt tests, the gravity sensors are tested for vertical acceleration characteristics. For example, the Scintrex sensor has the appropriate dynamic range and linearity. FIG. 8 shows example data from subjecting a Scintrex CG-3 sensor to vertical oscillations at five different periods ranging from 50 seconds to 3 seconds. A vertical shake table's position is recorded with a laser interferometer. The observed and calculated acceleration spectra are plotted. The average gravity values are unaffected by the oscillations. The position of the vertical shake table is monitored with a laser interferometer while recording the output of a Scintrex CG3 gravity sensor during a series of single frequency driving functions ranging from 0.02 Hz to 0.15 Hz. The upper traces 800 show the power spectra of the measured accelerations and the middle plot 810 shows the spectra predicted from the second derivative of the measured displacement. The bottom traces 820 show the gravity values averaged during disturbances at various frequencies. The averages agree to 0.02 mGal.

Using vertical and horizontal programmable shake tables, the CG-3 sensor is subject to simulated AUV motions like those Bellingham and coworkers have recorded. Once sensor evaluation is complete, the AUV-borne system can be constructed. A new set of gimbals, based largely on the existing ROVDOG gimbals, can be designed to fit into a 17″ glass ball, including mounting hardware. The gimbals can be fabricated and the ROVDOG sensor can be installed.

Also, much of the existing ROVDOG software can be used for this application. The software currently transmits data continuously, which is ideal for recording the data stream with the AUV computer. Certain functions, such as underway leveling, can be re-written to operate autonomously, rather than as a user initiated operation. Post-processing codes can also be written.

The operational AUV-borne gravimeter system can operate independent of the vehicle's power and data systems. The system can also include self-contained data loggers and batteries for the instrument. Existing commercial off-the shelf components can be used. For example, the computer system to communicate with the gravity sensor and the tilt sensors can include PC-104 computers that provide capable and compact computing platforms with a wide selection of add-on modules such as AIDs. The system can further include wireless radio modems that can send data through the glass spheres and permit fast data transfer without using a penetrator. Lithium-ion batteries provide a great deal of energy in compact packages. These are provided as non-limiting example implementations only.

An AUV-borne gravimeter is distinct from the submerged, towed and deployed systems with different applications. On-bottom relative gravity instruments are best suited for high precision (0.01 mGal) point measurements. ROVDOG and similar systems are designed for high-resolution surveying of modest extent in a relatively short time, as well as measuring deformations within a network over time. In contrast to these, underway gravity recording platforms are best suited for investigations requiring modest precision in exchange for rapid coverage of a large area. This is the primary target for an AUV gravimeter. In addition, an AUV gravimeter can open the door to using gravity measurements for projects currently beyond the capabilities of the other underway systems. The AUV gravimeter system as described in this specification can provide higher resolution surveys with much lower ultimate cost.

Further, an AUV deployed gravimeter as described in the AUV-borne gravimeter system makes far more efficient use of valuable ship time. The vessel can conduct other scientific investigations while the AUV is either diving or on deck for servicing. For example, an AUV dive program may consist of one 16-hour dive per day, with 3 hours required for launch and 3 hours for recovery (including transit to the launch/recovery points). The vessel is thus available for ¾ of the day to conduct other studies, such as multibeam swath bathymetry, seismic profiling, CTD profiling, and biological sampling. The effective day rate return provided by efficient dual use on a global class vessel is of order $17 k per day. The capital investment in an AUV-borne gravimeter can be recouped in a few days of ship operations.

AUV-Borne Gravimeter Applications

The AUV-Borne Gravimeter as described in this specification can be implemented in various applications. The following descriptions provide some of these example applications.

The Utility of Near-Sea-Floor Underway Gravity

Marine gravity can be measured on the sea surface and on the seafloor. Sea surface gravity measurements suffer from a lack of resolution in deep water because the source masses are far from the measuring instrument. The gravity signal from a two-dimensional feature with a wavelength of λ is attenuated by exp(−2πzλ⁻¹), where z is the distance between the source and the measurement point Narrow geologic features with wavelengths shorter than the ocean depth will be so strongly attenuated as to be virtually undetectable from surface gravity surveys. Satellite methods are limited to features of even greater wavelength for the same reason. In addition, the environment in which surface gravity is recorded is inherently noisy, due to the constant heaving of the ship.

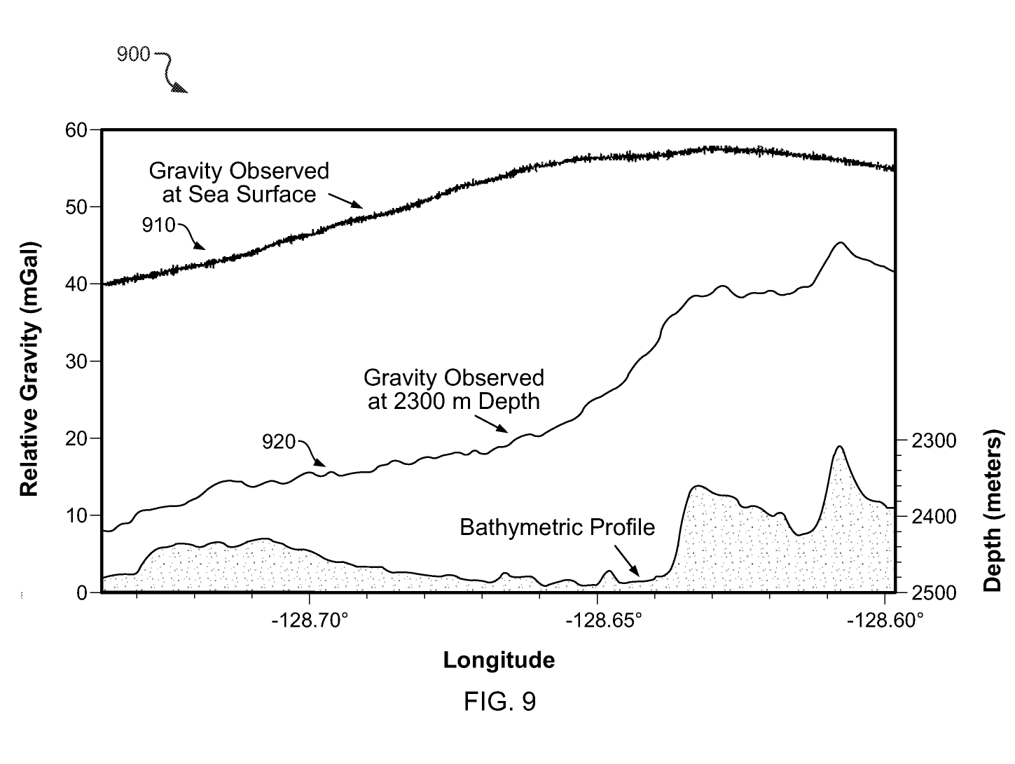

FIG. 9 shows examples of gravity measurements 900 obtained from the sea surface and seafloor. Two gravity profiles are shown collected across a seafloor mountain chain near Middle Valley, off the Juan de Fuca Ridge. The two gravity profiles include an observation made at the sea surface (upper trace 910) and one made just above the sea floor (lower trace 920). Both profiles are obtained with the same meter along tracks following the same horizontal coordinates (arbitrary offsets along the vertical axis were added for display purposes).

A near-bottom gravimeter can be towed at a depth of 2300 m to just skim the peaks whose profile is shown in the bottom of FIG. 9. As a comparison, gravity measurements are repeated while traversing the same track but with the gravimeter on the ship. The gravity signal produced by the density contrast between the rock and the seawater is much more pronounced in the towed data near the seafloor. Thus, the profile obtained near the seafloor provides a better estimate of the bulk density of these geological features.

FIG. 9 shows another potential advantage of an AUV gravimeter over a TOWDOG. The surface data collected on the ship shows high frequency noise from ship motion due to swell that is not completely filtered away. This noise is absent in the towed data (TOWDOG). However, the towed data show residual noise at an intermediate frequency. This is caused by imperfect depth control of the towed meter. Because a ship is constrained to sea level (on average over a minute or longer), there are minimal vertical accelerations for periods longer than about a minute. A submerged vehicle, however, has no such constraint. As a result, vertical accelerations of the TOWDOG, which are mostly but not completely removed by estimating vertical acceleration from the vehicle's depth record, introduce residual noise in the data.

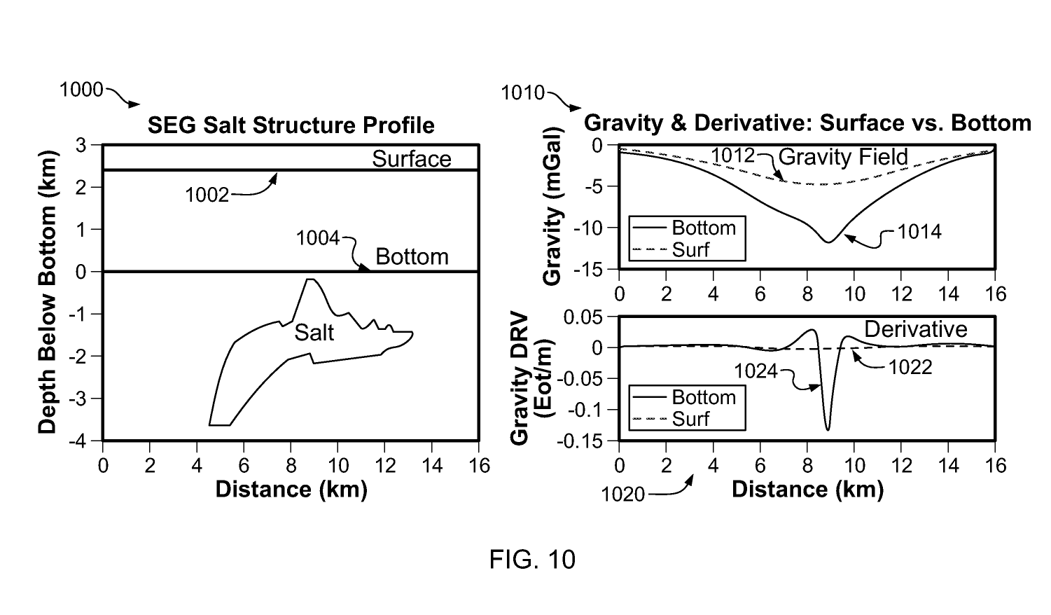

Similarly, FIG. 10 shows an example of simulated comparison of gravity data at the ocean surface and ocean bottom. The top right panel 1010 shows increased resolutions of gravity and the bottom right panel 1020 shows gravity 2nd vertical derivative, for near-bottom gravity versus a surface measurement, for the SEG salt model. For the gravity field, the near-bottom profile 1014 has 3 times the amplitude, and more resolved inflections than the surface profile 1012. For the vertical derivative, the near-bottom profile 1024 yields a large effect over the central peak and fluctuations over the flank, whereas the surface gradient profile 1022 is nearly flat. The data is calculated for the standard SEG salt model with an ocean depth of 2400 meters.

The panel on the left 1000 shows the geometry of salt mass and the simulated tracks at the ocean surface and bottom. According to equation 1 above, a surface measurement may not be able to resolve features smaller than the water depth. This is seen in the top-right panel, where the surface 1002 and bottom gravity 1004 anomalies are plotted. The bottom gravity anomaly exhibits both greater amplitude and resolution, particularly in the region of central dome intrusion. This effect becomes ever more pronounced when looking at the second vertical derivative of the gravity anomaly, as shown in the lower right panel. The bottom gravity anomaly derivative is able to resolve the smaller scale features around the central dome as well as the dome itself. By contrast, the surface gravity anomaly derivative is rather flat and devoid of features. This demonstrates that bottom gravity measurements yield higher resolution of geologic features when compared with surface measurements and should provide enhanced geological inversions and be better suited to data fusion with seismic and/or magnetotelluric data. Such resolution enhancement can be presented factoring in measurement noise in comparison with surface gradiometer methods.

Comparison of Surface Gradiometer Resolution

Gravity gradient is an alternative gravity-based geophysical survey method. Gravity gradient nominally contains more information in its 9-component tensor. In addition, gravity gradient eliminates certain noise components, such as that due to vertical heave, by dint of its gradiometer, which cancels common-mode accelerations. Contemporary gravity gradiometers are too large to be deployed in AUVs for bottom measurements, but rather are mounted on a survey ship. Such gradiometer onboard a ship is compared to the AUV-borne gravity system as described in this specification. Although smaller AUV-based gradiometer systems have been discussed in the literature [see, for example, Goldstein and Brett, 1998], no such system is available at present.

There are three aspects to be addressed when comparing sea-bottom gravity with surface gravity gradiometry:

1. Ability of AUV-borne gravimeter system vs. gradiometry to resolve geologic structures;
2. Possible availability of more information in the gradiometer tensor; and
3. Economics of surface vs. autonomous operation.

The gravity and its gradient can be considered for a sphere with a differential mass M relative to its surroundings. The vertical component of the gravity field is given by equation 4 as follows:

$${g}_{z} = γ M \frac{z}{{r}^{3}} \qquad ( 4 )$$

Where γ is the gravitation constant, z is vertical height of the observation point, and r is the radial distance from the center of the sphere to the observation point (i.e., r²=x²+y²+z²). The vertical gradient is simply the spatial derivative of equation 4 given by

$$\frac{\partial {g}_{z}}{\partial z} = - γ M [ \frac{3 {z}^{2} - {r}^{2}}{{r}^{5}} ] \qquad ( 5 )$$

This simple model shows that gradient data fall off as a function of distance one power faster than do gravity data. The primary advantage of the AUV-borne gravimeter system over other methods is resolution, which is an important factor in geophysical exploration. Resolution may be measured in many ways including being able to measure a geophysical signal buried in the midst of measurement noise (i.e. signal-to-noise ratio or SNR), the smallest recordable wavelength for a given sensor altitude (as determined by Eq. 1), the error in estimating geometric parameters such as the thickness of a salt body, and the shortest possible along-track wavelength, which is a function of filter length and survey speed. The AUV-borne gravimeter system has a resolution advantage using all of these metrics.

A common way to describe gravity systems is the ‘error at minimum wavelength’ designation (Fairhead and Odegard, 2002). For shipborne surveys, typical resolutions are about 0.5 mGal at 1 km, and the best ship surveys are 0.2 mGal at 0.25 km. The latter takes into account an optimal shipborne gravity meter using a 100 second low-pass filter to suppress ship heave at 5 knots. However, this metric does not take in to account the height above the mass anomaly, which may be many times this theoretical resolution. Thus, the 0.25 km figure only applies if the water is shallower than 0.25 km, which is very misleading. The actual resolution of a ship system cannot be finer than the water depth. With the AUV-borne system, also running at 5 knots and using a 100 second filter, a noise estimate of 0.1 mGal at 0.25 km can be achieved. However, the 0.25 km is actually achievable because the sensor is at the seafloor, not at the surface.

Li (2001) parameterized gravity resolution as determined by the accuracy of the estimate of the thickness of a salt disk 4000 m diameter buried beneath the seafloor for both gravity field and gradiometer measurements. This thickness estimation accuracy increases as the measurement noise floor goes down, and as the sensor is closer to the source mass. Also, as discussed above, gravity has an inherent advantage over gradiometry as the top of the source mass deepens. The AUV-borne system described in this specification uses Li's curves to compare a shipborne gradiometer survey with a 2-Eötvös noise floor to the AUV-borne technique. The comparison is made for a range of water depths and depth to the salt top. Also, the resulting thickness resolution is contoured, and the area of resolution better than 50 meters is shaded-in.

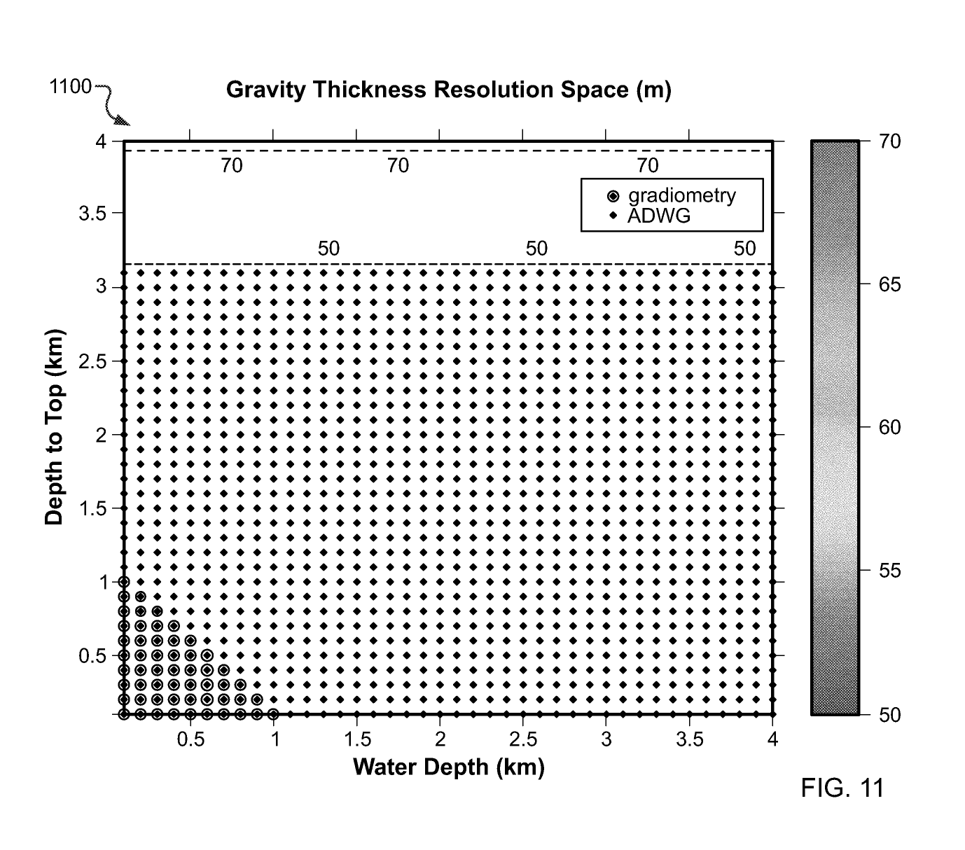

FIG. 11 shows an example resolution of estimating the thickness of a salt lens as a function of water depth (X axis) and depth to the salt top (Y axis). Fifty meters or better is set as high resolution. The AUV-borne technique (solid dots) can estimate the thickness with 50 meters of accuracy over 75% of the parameter space. In contrast, the surface gradiometry (open circles) can only achieve this over the shallowest 3% of the parameter space. FIG. 11 includes the 50 and 70-meter contour lines for the AUV-borne system and technique.

This demonstrates the resolution advantage of near-bottom gravity measured with 0.1 mGal of noise. Fifty meters of thickness estimation accuracy is certainly a very good resolution level, and this would allow a clear picture of the salt layer in FIG. 10, and for many other salt structures. A 500-meter thickness resolution would not add any value to seismic estimations. The 2-Eötvös surface gradiometer is a much poorer-resolution instrument in comparison.

The resolution comparison between AUV-borne system and surface gradiometry is also examined as a function of SNR. A parametric comparison of the SNR in both methods is executed for a buried 2D, 400 m thick prism with a density contrast of 400 kg/m3 versus the surrounding rock. The AUV-borne gravity is simulated to be at the ocean bottom with a root mean square (rms) noise level of 0.1 mGal vs. a shipborne gravity gradiometer.

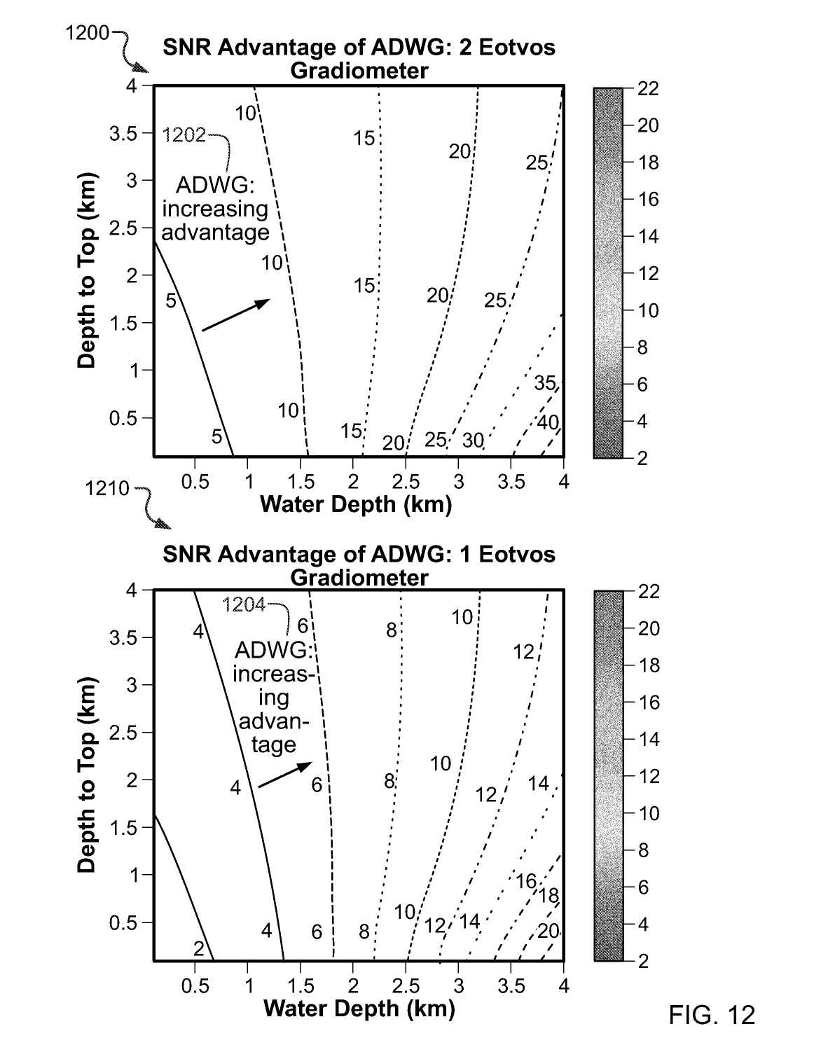

FIG. 12 shows an example parametric study of SNR advantage of AUV-borne gravimeter system vs. a surface gravity gradiometer. The data shown in FIG. 12 is recorded at the ocean bottom with an rms noise level of 0.1 mGal. The ratio of SNRs for the two methods is contoured as a function of water depth (X axis) and depth below the ocean bottom of a mass anomaly (Y axis). The left panel 1200 shows the SNR ratio for a gradiometer survey with 2-Eötvös white noise, and the right 1210 is the same quantity for a 1 Eötvös noise level. The AUV-borne system is nearly everywhere superior in resolution vs. the 2-Eötvös gradiometer and superior to the 1-Eötvös gradiometer over about 80% of the parameter space, for example for all water depths>1.4 depending on the source mass depth as determined by ratios>4.

The surface gradiometer advantage is restricted only to the small lower-left region, below about 0.5 m in water depth and for depths to the top of the source mass of less than 1 km. The noise estimates of 1 to 2 Eötvös for the marine gradiometer survey are described in Li, 2001 and Goldstein and Brett, 1998.

The gradiometer data do not intrinsically contain more information than the gravimeter data. The gradients can be derived from the gravity measurements in a plane. This can be derived starting with a well-known theorem from potential theory called Green's equivalent layer. The equivalent layer theorem states that the potential caused by a three-dimensioned body is indistinguishable from a thin layer of mass spread over any of its equipotential surfaces (see for example, Blakely, 1996). Once the hypothetical surface distribution of mass is determined, the field can be inverted to a regularized matrix of points about the original the layer (Blakely, 1996 and Cooper, 2002). There is then sufficient information to compute the full 9-element gradient tensor using standard equations. In practice, this equivalence is for a band-limited gravity signal, which is spatially sampled with tighter line spacing than the gradiometer. If gradients of spacing Δx are needed, the gravity should be sampled with a minimum cross-track spacing of Δx/2. Also, gravity gradients can only be computed within the interior of the grid of gravity measurements and sufficiently far away from the ends of the survey so as to not be affected by insufficient geometrical data constraints near the edge (i.e. so-called edge effects). But given a sufficiently planned AUV-borne gravity survey with a 0.1-mGal noise floor, all gradients of interest within the survey boundaries can be calculable from the vertical gravity measurements.

Further, in comparing the AUV-based gravimeter and surface gravimeter/gradiometer measurements, the economics of taking surface data versus the AUV operation are considered. The surface gravimeter measurements are usually piggybacked on seismic surveys to minimize its cost. The added cost of an AUV-based survey is justified by the increased resolution achievable at the ocean bottom. Because exploration companies do engage stand-alone gravity/magnetic surveys (Business Wire 2000) and gradiometer surveys are predominately on dedicated vessels, an equitable comparison of surface-based survey versus AUV-based survey should consider the mean speed of the survey vessel, area coverage (including turnaround times for the tracks), and specific to AUVs, battery life and number of units launched.

For example, a typical geophysical surface ship travels at between 5 and 10 knots but requires considerable time to execute turns. The Bluefin-21 AUV travels at a mean cruising speed of 2.7 knots and has a 20+hour battery life, but can turn around very quickly. More advanced AUVs, such as the HUGIN AUV travel at 4 knots with a fuel cell life of 60 hours for a total range of 440 km. Use of multiple AUVs launched from a single support ship can allow greater area coverage rate and continuous operation by staggering battery recharging periods.

Data Fusion of AUV-Borne System Data with Other Geophysical Methods

The AUV-borne system has at least two primary usage strategies: 1) Performing pre-seismic regional surveys to generate data on geological parameters such as the different terrains in an area, depth of sedimentary basins, and the occurrences of structures such as salt domes, anticlines and igneous intrusions; and 2) Performing detailed, high-resolution surveys where seismic, magnetic and/or magnetotelluric data already exists or is being measured simultaneously with the gravity.

For case 1) the AUV-borne system provides a regional tool with lower noise and better resolution than surface gravity/gradiometry. The AUV-borne system can be used to assess broad features from which geophysicists can plan where to best allocate their more expensive seismic resources. The survey track spacing for this will be wider than a local, detailed survey, in order to gather long-wavelength information over a wide area. However, the 1-D along-track profiles used to create this will still have maximum resolution, and the AUV can be programmed to do tracks of denser spacing over areas that look promising while it is on-site.

For case 2), potential field data from AUV-borne system add a measurement of independent quantities to seismic and magnetotelluric (MT) methods. This can help to constrain the interpretation of the geological structure that these methods intend to map, especially in seismically difficult areas such as sub-salt, steeply-dipping salt imaging, and in imaging below basalt layers (Etgen 1984, Heincke et al., 2006). Additionally, gravity methods have the ability to estimate the thickness of both salt and basalt flows, as seen in Li (2001).

Also, multiple types of geophysical data can be used in complex areas such as thrust belts, where seismic data are often of poor quality (e.g. Dell'Aversana, 2001). Interpretation is greatly aided by the addition of gravity and magnetotelluric data. For this reason, gravity and magnetic data fusion can be used to enhance the decision making process involved in geophysical exploration (Edcon, 2007).

Independent geophysical data sets can be used in the objective mathematical determination of geologic structure via statistical inversion methods. The gravity field is often used in formal inversion procedures because its primary causative property, density, is a basic property of rocks and is often related to seismic velocity and electromagnetic conductivity via quantifiable relations. In joint inversion, the information from different sources is used to reduce the non-uniqueness inherent in an inversion based upon one data type alone. In particular, gravity data can be jointly inverted with magnetotelluric data alone (e.g., Kaushik et al.), seismic data alone (Johnson et al., 2003, Roy et al., 2005), or together with both magnetotelluric and seismic data (Heincke et al., 2006).

Targets for Gravity Surveys

Example targets for surveying with an AUV-borne gravimeter include implementations in which the gravity data is inverted to estimate density distributions of underlying formations. One such target is aimed at a time-varying process in which gravity variations would be detected in repeated surveys. The signals in time varying studies are typically much smaller than in static studies. These studies require the lower noise results that can be obtained from an AUV survey.

Mid-Ocean Ridge Studies

Gravity is frequently used to determine the bulk density of the rock along spreading centers. The mechanisms responsible for the morphology of mid-ocean ridges may not be well characterized. For example, the extent to which mantle upwelling is dominated by plate drag or driven by buoyancy forces may not be clear. The answer may be different for slow spreading centers compared to fast. The bulk density of the rock may be related to the conditions during emplacement as well as the amount of fracturing present now.

Density values determined from gravity measurements can vary from study to study. Examples which reveal the variability include: 2400 kg/m³ averaged over the Juan de Fuca Ridge [McNutt, 1979]; 2600 kg/m³ averaged over the Mid-Atlantic Ridge [Cochran, 1979]; 2330 kg/m³ for the East Pacific Rise (EPR) between 13° N and 18° S [Cochran, 1979]; 2620 kg/m³ for the EPR at 21° N [Luyendyk, 1984]; and 2700 kg/m³ for Axial Seamount [Hildebrand et al., 1990]. In more recent studies across the EPR, Cochran et al. [1999] determined shallow crustal densities of 2410 kg/m³ near 9° N and 2669 kg/m³ at a second EPR profile 30 km north of the first. Stevenson et al. [1994] obtained a result of 2420 kg/m³, which agrees well with the first value but not the second. At the Juan de Fuca Ridge, Holmes and Johnson [1993] found densities that ranged from 2360 kg/m³ near the ridge axis to 2880 kg/m³ on the flank some 20 km away.

These values are significantly smaller than densities of unfractured oceanic basalt samples measured in the lab to be in the range of 2900 to 3000 kg/m3. The variability can be caused by fracturing and increased porosity in the rock: up to 25%. Such fracturing plays an important role in the transport of heat from depth to the seafloor interface. This fracturing, which contributes to the hydrothermal circulation which supports diverse biological communities in the mid-ocean ridge, could be better mapped with higher resolution gravity data covering more ridge topography. Quantifying the variations in density and hence porosity is a critical component in the development of integrated models of ridge geology and biology.

Recent density determinations in ridge environments have been made by near or on bottom gravity surveys using submersibles or packages lowered to the seafloor from ships. Virtually all of them, however, rely on comparing cross-axis profiles with the bathymetry; often referred to as the Nettleton method [Nettleton, 1976]. There is ample room for ambiguity in such approaches. As the researchers often admit, features other than bathymetry vary across the axis. Regional gravity trends or layering that follows the seafloor relief can bias estimates of shallow crustal density as determined from Nettleton profiles.

A better approach is to map a section of the ridge over an area rather than only along a profile. Along-axis gravity signals are reduced in amplitude simply because the relief is less variable, but the potential for contamination from other parameters that vary along the ridge axis is lessened, or at least different from those that vary across the ridge axis. Cross-axis profiles are used more widely because the signals are larger. Gravity interpretations are somewhat ambiguous because of non-uniqueness, but with some simple assumptions on density boundaries, correlating the gravity signal with the topography at different wavelengths can allow one to assess the level at which the shallow density inferences are contaminated by deeper features. The study of shallow crustal density around a ridge rise crest is a candidate for improved resolution if a means is provided to quickly cover a larger area with less noise. An AUV-borne system as described in this specification can be beneficial to such studies.

As a guide to the resolution in porosity that can be afforded by an AUV gravity survey system having 0.1 mGal resolution, the following are noted: in the notation of Pruis and Johnson [1998], take ρₘ as the density of unfractured basalt, ρ_{b} as the bulk density of a formation determined with a Nettleton profile, and ρw as the density of water; the bulk porosity φ of the formation is given by φ=(ρₘ−ρ_{b})/(ρₘ−ρ_{w}). For a gravity resolution of 0.1 mGal and topographic relief of 25 m, the density resolution is 100 kg/m³ (this comes from the gravitational attraction of a slab of thickness t and density ρ being equal to 2πGρt). Using the expression for φ above and a density of basalt of 3000 kg/m³, this translates to a porosity detection threshold of 5%.

A feature near mid-ocean ridges of current interest is the series of dike swarms reported by Cochran et al. [1999] based on their Alvin survey of the East Pacific Rise. They model Bouguer anomalies characterized with 100-200 m lateral dimension and amplitudes of a few mGal as being caused by dikes feeding off-axis volcanism. The amplitudes are such that the signals cannot be from shallow feeders or lava tubes; rather they likely extend to depths of several hundred meters to account for the size of the gravity signals. The existence of such features, if typical, can have an important impact on a model of ridge construction. The extent to which the seafloor is created from extrusive flows or from buried sheet dikes can be an important issue. The confirmation of the existence of such dikes can be a prime target for an AUV-borne gravimeter.

An interesting feature of the Juan de Fuca Ridge-Axial Seamount can be surveyed with the towed gravity meter. However, gravity data obtained from an AUV can produce a better estimate of the density variations within the volcanic edifice and thereby shed light on its internal plumbing. Also, using the AUV, a time variable study can be performed to aid in mapping lava flow and magma chamber depletion after eruptions. The time varying signals can be rather small: of order 1 mGal following an eruption similar to those seen every few years there. However, this is within the range of an AUV borne gravimeter. Again, the increased coverage and resolution afforded by using an AUV rather than a towed vehicle can benefit such a time varying survey with small signals.

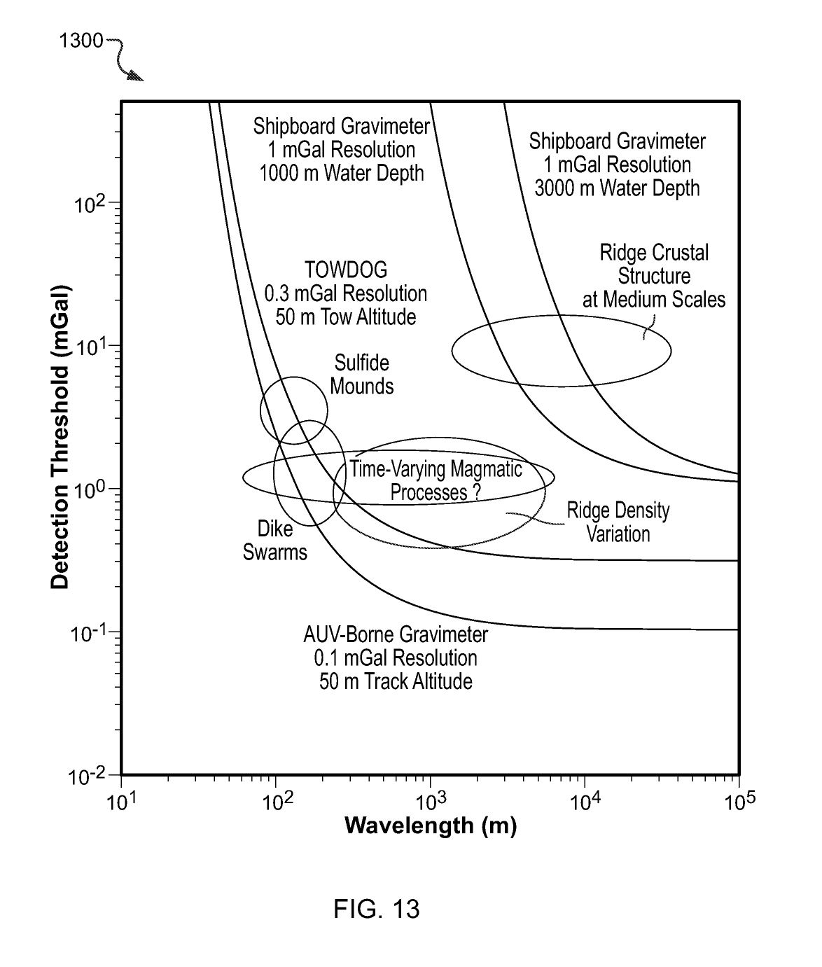

FIG. 13 shows an example of detection threshold as a function of wavelength. The data 1300 shown in FIG. 13 summarizes a relationship between instrument capabilities and scientific targets. The detection thresholds for shipboard gravimeters at two different altitudes, TOWDOG, and the design goal of an AUV-borne gravimeter are plotted as a function of anomaly wavelength. Also plotted are rough estimates of the signal sizes associated with different processes. Many scientific targets are essentially undetectable from the surface. However, an AUV-borne gravimeter has the spatial and signal resolution necessary to investigate these targets.

As shown in FIG. 13, a particular system can detect signals in the region above each curve. Most of the targets are undetectable from the sea surface, especially in deep waters. Estimates of the target signal amplitudes and wavelength can be estimated from Ballu et al. [1998] (ridge crustal structure at medium scale), Cochran et al. [1999] (dike swarms), Holmes and Johnson [1993] (ridge density variations) and the data from Middle Valley.

Under-Ice Surveys

Detailed deep surveys of the seafloor beneath the Arctic ice cap are not likely possible with existing instruments using the onboard gravimeter or the towed gravimeter. The SCICEX project, which involved U.S. Navy nuclear submarines, has collected some gravity data under the Arctic sea ice [Coakley and Cochran, 1998], but at a depth only a few hundred meters below the surface. At present, it is unlikely that an unclassified follow-on cruise will occur in the near future (Coakley, personal communication, 2003). An AUV gravity survey as described may provide a viable method to collect high quality, broad coverage data near the Arctic Ocean floor.

Exploration Geophysics

Oil companies have long employed ocean surface gravity surveys to help delineate oil-bearing features, most notably salt structures (which have large density contrasts). Current exploration efforts are turning towards the deep ocean (below 1000 m). To study features in the salt structure having wavelengths less than a few km, surface gravity surveys are inadequate. Near bottom gravity surveys of deep ocean structures in the Gulf of Mexico promise to aid in the search for hydrocarbons.

Broad Application and Impact

The intellectual merit of this proposal is its focus on the development of an important new tool for geophysical research. Marine geology, geophysics and geodesy will clearly benefit from gravity mapping over larger scales with finer spatial resolution and lower noise. Fundamental physics limits the detection threshold at short lengths scales for sea surface instruments, thus necessitating a near-bottom sensor platform. The long-term engineering goals seek to build a sensor payload that is easily compatible with different AUV systems.

The broader impacts of this work are clear. Such an instrument will improve the sensor infrastructure of the ocean science community. Surface gravimeters are often part of a large vessel's dedicated instrumentation, and indeed log continuously while underway. AUV systems are clearly the future of marine studies, but AUV sensors such as gravimeters are also needed.

An AUV-borne gravimeter also allows dual use of valuable ship time in an efficient and productive manner. An AUV-borne gravimeter also has clear applications for offshore oil and gas exploration, and will aid in increasing the energy resources available to the nation.

Coverage Rate and Mission Profiles

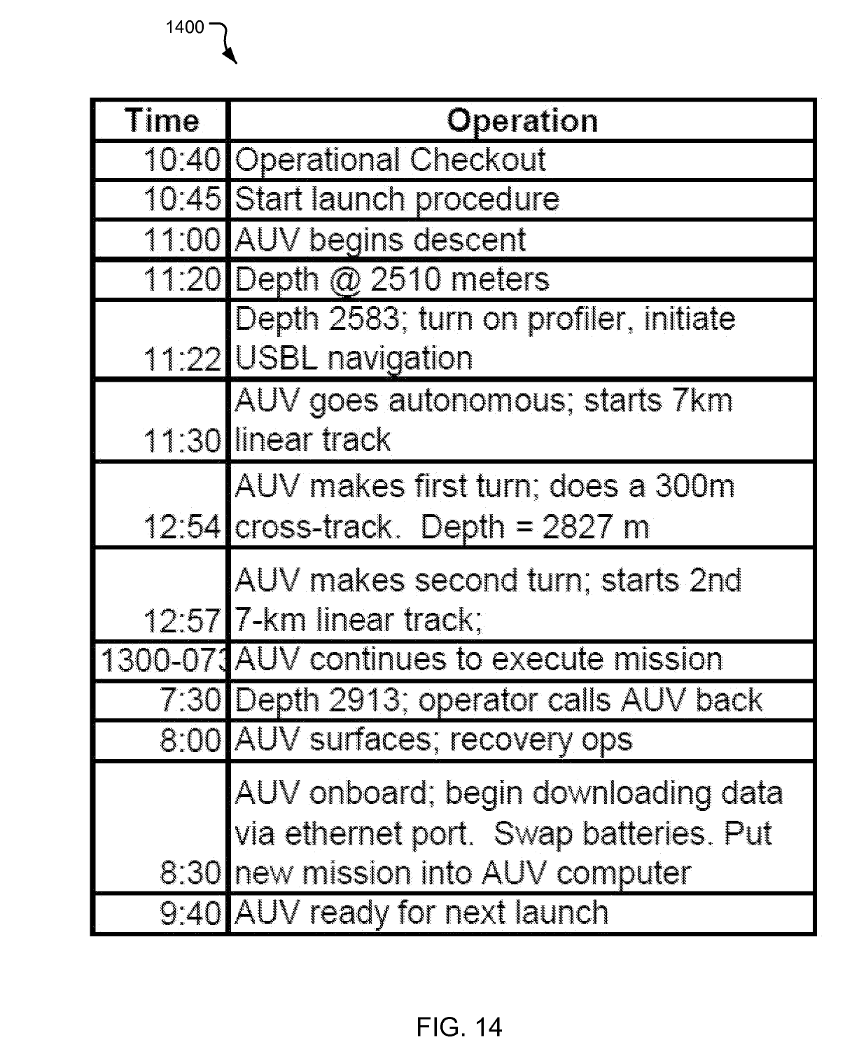

FIG. 14 is a table 1400 showing a Bluefin-21 one-day example mission profile. Launch and recovery each take about 15 minutes. The descent to 2500 meters takes 20 minutes, surfacing from 2913 meters takes 30 minutes, and data download and battery swapping takes 70 minutes. The AUV executes its autonomous operations (7 km tracks with 300 m cross-track spacing) for 20 hours before being called back to the surface. The AUV traverses one 7 km track in 84 minutes for an average speed of 2.7 knots, and takes about 4 minutes to do two turns and a cross track. This translates into about 96 line-km of closely spaced tracks (300 m) in a little less than one day of operation. One AUV can be launched once per day to cover a mission, or two or three AUVs can be used with a staggered launch schedule to increase the coverage rate. While the AUVs are doing their mission, the support ship can be doing ancillary tasks such as preparing new batteries and logging CTD profiles (used for pressure-to-depth conversion).

An example of a support ship for AUV operations includes the RN Sproul, a typical small-sized research vessel of length 125 feet. For commercial surveys, different ship support options can include: 1) a small ship like the Sproul for stand-alone operations, 2) usage of one of the group of smaller ships surrounding and supporting a seismic streamer boat, or 3) the seismic ship itself. A selection from these options can be made by balancing the tradeoff between proper AUV support and low cost.

Additional Applications (Gravity Reservoir Monitoring, Magnetics, CSEM)

The AUV-borne system described in this specification can have additional applications and can implement technologies including: 1) Petroleum reservoir monitoring from on-station underwater gravity measurements, 2) AUV-based magnetics data using an onboard scalar magnetometer, 3) Electromagnetics (either magnetotellurics or controlled-source EM) from simultaneous electric and magnetic field measurements, and 4) Use of an onboard chemical sniffer to detect hydrocarbon seeps at depth.

Reservoir monitoring can be performed using the AUV-borne system as described in this specification. An example of reservoir monitoring includes gravimetric time-varying oil- and gas-field monitoring (Eiken et al., 2000 and 2004). The SIO gravity group constructed and deployed an instrument for use in sea floor gravity observations called the ROVDOG (Remotely Operated Vehicle Deep Ocean Gravimeter, Sasagawa et al., 2003), which used an ROV to place the Scintrex CG-3M gravimeter sensor on concrete benchmarks strategically placed around an oilfield. Measurement repeatability ranged between 0.005 and 0.010 mGal (about 20 dB better than the noise level proposed for the AUV-borne gravimeter system). ROVDOG was used in the North Sea during surveys in 1998, 2000 and 2002 to monitor gravity changes caused by fluid withdrawal from a large undersea hydrocarbon reservoir. This pilot project proved the technology as being extremely useful in reservoir monitoring, but the process is very labor-intensive, as it involves an ROV operator and a specialist to run the gravity meter. An AUV automatically performing this process can revolutionize gravity-based reservoir monitoring and make it an every-day occurrence in reservoirs around the world. The value of better reservoir management is huge and the cost of ‘permanent’ AUV operations is relatively small.

The AUV can be designed to stop its forward motion to take the gravity data, either by: 1) automatically navigating to a benchmark and parking on it while it makes the measurement, or 2) hover in place during the gravity measurement. Some AUVs already have hovering capability (Ron Walrod, personal communication), and others could be modified using special adaptive navigation electronics and software to achieve hovering.

A support ship is not a requirement. An AUV housed in a sub-sea garage can collect data for reservoir density maps without surface vessel support. When docked in the garage, the AUV's batteries are charged. At the same time, high bandwidth survey data is transmitted up-link and mission-planning instructions are sent by downlink. The AUV can make the rounds of benchmark sites to measure the reservoir, and return to the home platform periodically. This configuration can keep the AUV out of the way of other oil or gas field operations, yield automatically updated gravity data on all sites on a weekly or monthly basis, and give oil-field operators valuable snapshots in time of the density profile across the entire field.

The addition of a magnetometer, such as an optically pumped potassium or helium scalar variety, can add a useful data set independent of gravity measurements for an incremental cost and effort. Magnetic data can be used as companion data set to gravity data, either for pre-seismic regional studies, or high-resolution studies in the prospect definition phase (e.g. Gibson and Millegan, 1998). To add a high-precision magnetometer the design of the AUV-borne system can be modified to consider the following: 1) increase in power needed for the magnetometer sensor, and 2) a boom added on the end of the AUV to place the magnetic sensor sufficiently far away from the AUV body to lower its interference noise. The power needed for adding a magnetometer may require increasing the AUV power source, or utilizing a state-of-the-art, low-noise low-power magnetometer such as being developed at the Systems Center, San Diego (SPAWAR) (Ando et al., 2005) and NIST (Schwindt et al., 2004).

Another example of technological addition to the AUV-borne system includes recording electromagnetics from E and B-field measurements, in conjunction with a simultaneous magnetotelluric (MT) survey, or a CSEM survey. Gravity and EM data include independent quantities, such as density and electrical conductivity that can be used together either in joint inversions (Kaushik et al.) or both combined with seismic (Heincke et al., 2006).

For example, current methodology of performing EM surveys can be modified using ocean-bottom sensors by making the EM measurements on a moving or hovering AUV. The placement of E and B-field sensors on the AUV can allow a more rapid measurement of subsurface conductivity and record collocated gravity data. This can help to remove ambiguities from the geological interpretation.

In addition, a chemical sniffer can be added to detect hydrocarbon seeps. A chemical sniffer can be used in exploration on its own because of the proximity of the AUV to the seafloor. For example, a chemical sniffer can be used in hydrocarbon exploration as another independent measurement that is fused with gravity, magnetic, and possibly electric field data, all taken on the same AUV platform.

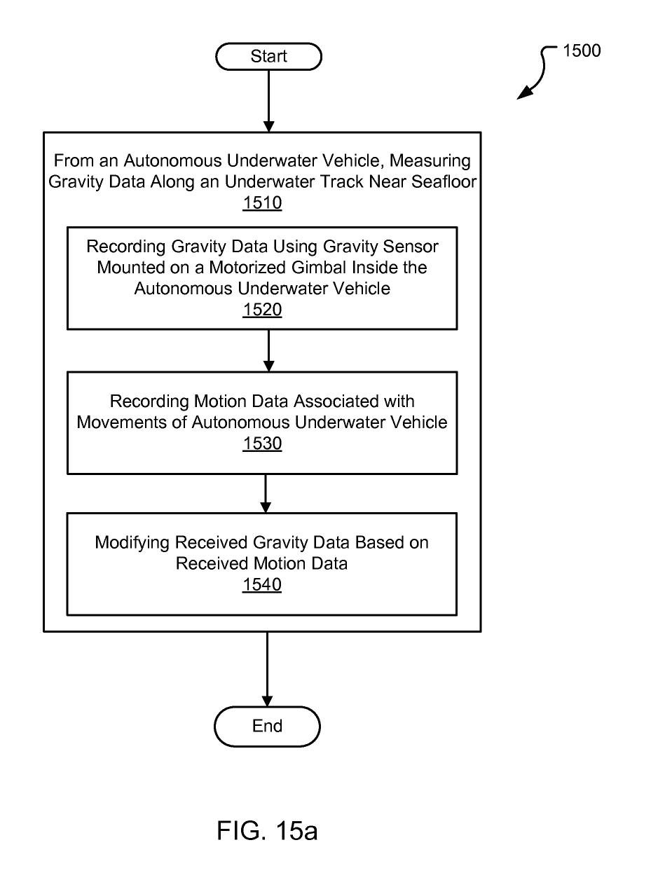

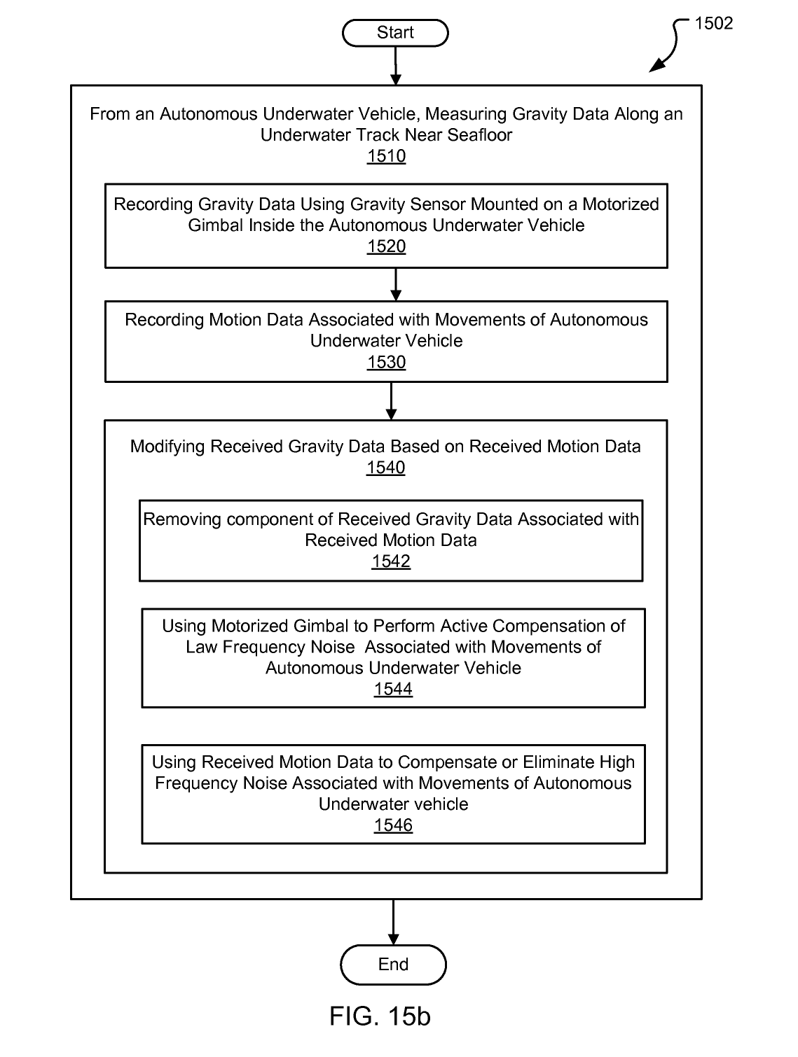

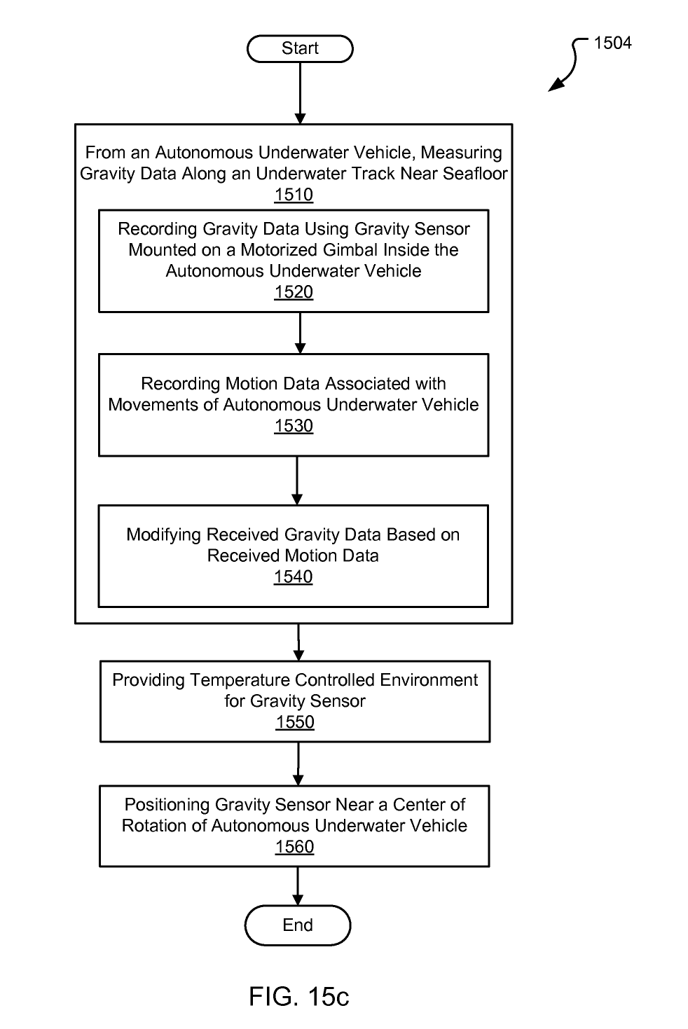

FIGS. 15a, 15b, and 15c are process flow diagrams showing various processes 1500, 1502 and 1504 for performing gravimeter survey using an AUV-borne gravity meter sensor system. As shown in FIG. 15a, from an autonomous underwater vehicle, a gravity sensor system can be used to measure gravity data along an underwater track near the seafloor (1510). Measuring the gravity data included recording gravity data using a gravity sensor mounted on a motorized gimbal inside the autonomous underwater vehicle (1520); recording motion data associated with movements of the autonomous underwater vehicle using a motion sensor mounted to the motorized gimbal (1530); and modifying the received gravity data based on the received motion data (1540).

As shown in FIG. 15b, modifying the received gravity data can include removing a component of the received gravity data associated with the received motion data (1542). The motorized gimbal can be used to perform active compensation of low frequency noise associated with the movements of the autonomous underwater vehicle 1544). Additionally, the received motion data from the motion sensor can be used to compensate or eliminate high frequency noise associated with the movements of the autonomous underwater vehicle (1546).

FIG. 15c shows additional features of the process 1504. A temperature controlled environment can be provided for the gravity sensor system (1550). Additionally, the gravity sensor can be positioned near a center of rotation of the autonomous underwater vehicle (1560).

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and may be implemented in a high-level procedural and/or object-oriented programming language, and/or in assembly/machine language. As used herein, the term “information carrier” comprises a “machine-readable medium” that includes any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal, as well as a propagated machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a WAN, and the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Only a few implementations and examples are described and other implementations, enhancements and variations can be made based on what is described and illustrated in this application.

What is claimed is what is described and illustrated, including:

1. A system comprising:
an autonomous underwater vehicle comprising a sensor system holding area; and
a gravity sensor system to fit inside the sensor system holding area of the autonomous underwater vehicle comprising:
a motorized gimbal to provide a leveled sensor platform,
a gravimeter sensor mounted onto the motorized gimbal to measure gravity data,
a motion sensor mounted onto the motorized gimbal to measure motion data associated with movements of the autonomous underwater vehicle, and
a sensor system housing to encapsulate components of the sensor system including the motorized gimbal, the gravimeter sensor and the motion sensor.

2. The system of claim 1, wherein the sensor system housing comprises a glass sphere to provide positive buoyancy for the sensor system.

3. The system of claim 1, wherein the motion sensor comprises a non-gyroscopic tilt sensor.

4. The system of claim 1, wherein the non-gyroscopic tilt sensor comprises an accelerometer.

5. The system of claim 1, comprising a computing system to communicate with the gravimeter sensor and the motion sensor.

6. The system of claim 5, wherein the computing system is configured to:
receive gravity data from the gravimeter sensor;
receive motion data from the motion sensor; and
modify the received gravity data based on the received motion data.

7. The system of claim 6, wherein the computing system is configured to modify the received gravity data by removing a component of the received gravity data associated with the received motion data.

8. The system of claim 6, wherein the motorized gimbal is configured to generate movements to perform active compensation of low frequency noise associated with the movements of the autonomous underwater vehicle.

9. The system of claim 6, wherein the computing system is configured to use the received motion data from the motion sensor to compensate or eliminate high frequency noise associated with the movements of the autonomous underwater vehicle.

10. The system of claim 1, wherein the gravity sensor system comprises an insulation unit mounted to the gimbal to encapsulate the gravity sensor in a temperature controlled environment, wherein the gravity sensor is indirectly mounted to the gimbal using the insulation unit.

11. The system of claim 1, wherein the gravity sensor system is positioned near a center of rotation of the autonomous underwater vehicle.

12. A method comprising:
at an autonomous underwater vehicle, measuring gravity data along an underwater track near a surface of seafloor, wherein the measuring comprises:
recording gravity data using a gravity sensor mounted on a motorized gimbal inside the autonomous underwater vehicle;
recording motion data associated with movements of the autonomous underwater vehicle using a motion sensor mounted onto the motorized gimbal; and
modifying the received gravity data based on the received motion data.

13. The method of claim 12, wherein modifying the received gravity data comprises removing a component of the received gravity data associated with the received motion data.

14. The method of claim 12, comprising:
using the motorized gimbal to perform active compensation of low frequency noise associated with the movements of the autonomous underwater vehicle.

15. The method of claim 12, comprising:
using the received motion data from the motion sensor to compensate or eliminate high frequency noise associated with the movements of the autonomous underwater vehicle.

16. The method of claim 12, providing a temperature controlled environment for the gravity sensor.

17. The method of claim 12, comprising:
positioning the gravity sensor near a center of rotation of the autonomous underwater vehicle.

18. An apparatus, comprising:
a gravity sensor system sized to fit inside an autonomous underwater vehicle comprising:
a motorized gimbal to provide a leveled sensor platform,
a gravimeter sensor mounted onto the motorized gimbal to measure gravity data,
a motion sensor mounted onto the motorized gimbal to measure motion data associated with movements of the autonomous underwater vehicle, and
a sensor system housing to encapsulate components of the gravity sensor system including the motorized gimbal, the gravimeter sensor and the motion sensor.

19. The apparatus of claim 18, wherein the sensor system housing comprises a glass sphere to provide positive buoyancy for the sensor system.

20. The apparatus of claim 18, wherein the motion sensor comprises a non-gyroscopic tilt sensor.

21. The apparatus of claim 20, wherein the non-gyroscopic tilt sensor comprise an accelerometer.

22. The apparatus of claim 18, comprising a computing system to communicate with the gravimeter sensor and the motion sensor.

23. The apparatus of claim 22, wherein the computing system is configured to:
receive gravity data from the gravimeter sensor;
receive motion data from the motion sensor; and
modify the received gravity data based on the received motion data.

24. The apparatus of claim 23, wherein the computing system is configured to modify the received gravity data by removing a component of the received gravity data associated with the received motion data.

25. The apparatus of claim 23, wherein the motorized gimbal is configured to generate movements to perform active compensation of low frequency noise associated with the movements of the autonomous underwater vehicle.

26. The apparatus of claim 23, wherein the computing system is configured to use the received motion data from the motion sensor to compensate or eliminate high frequency noise associated with the movements of the autonomous underwater vehicle.

27. The apparatus of claim 1, wherein the gravity sensor system comprises an insulation unit mounted to the gimbal to house the gravity sensor in a temperature controlled environment, wherein the gravity sensor is indirectly mounted to the gimbal using the insulation unit.

28. The apparatus of claim 1, wherein the gravity sensor system is positioned near a center of rotation of the autonomous underwater vehicle.
